(19) United States
(12) Patent Application Publication
(10) Pub. No.: US 2007/0181039 A1
(43) Pub. Date: Aug. 9, 2007

(54) Drying shrinkage-reducing agent

(75) Inventors: Takashi Yamamoto, Suita-shi (JP); Mari Masanaga, Suita-shi (JP); Hiroshi Kawabata, Suita-shi (JP)

Correspondence Address: BUCHANAN, INGERSOLL & ROONEY PC, POST OFFICE BOX 1404, ALEXANDRIA, VA, 22313-1404, US

(73) Assignee: Nippon Shokubal Co., Ltd., Osaka-shi (JP)

(21) Appl. No.: 10/590,481

(22) PCT Filed: Mar. 15, 2005
(86) PCT No.: PCT/JP05/05070

§ 371 Date: Aug. 24, 2006

(51) Int. Cl. C04B 28/06

(52) U.S. Cl. 106/696; 524/5

(57) ABSTRACT

A drying shrinkage-reducing agent which comprises a polymer containing as an essential component at least one structural unit (I) represented by the following formula (1): 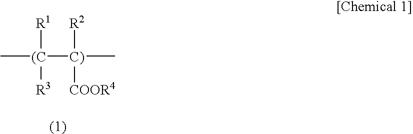
wherein R¹, R², and R³ independently stand for a hydrogen atom, a methyl group, or a —(CH₂)ₚCOOX group, wherein X stands for a hydrogen atom, a monovalent metal, a divalent metal, an ammonium group, an organic amine group, or a hydrocarbon group, and p is an integer of 0-2; and R⁴ stands for a hydrocarbon group of 4-30 carbon atoms, and exhibiting surface tension in the range of 25-50 mN/m in a solution containing 0.2 mass % of the polymer in a cement supernatant is provided. The drying shrinkage-reducing agent manifests no dispersibility in an amount capable of attaining necessary drying shrinking-reducing properties and, when used in combination with a dispersing agent, acquires ability to adjust the dispersibility and the drying shrinkage-reducing properties fit for the purpose.

### TECHNICAL FIELD

This invention relates to a drying shrinkage-reducing agent. Particularly, this invention relates to a drying shrinkage-reducing agent for reducing the shrinkage occurring in a hydraulic material, particularly in concrete members, due to drying. More particularly, this invention relates to a drying shrinkage-reducing agent which manifests no dispersibility in an amount capable of attaining necessary drying shrinking-reducing properties and, when used in combination with a dispersing agent, acquires ability to adjust the dispersibility and the drying shrinkage-reducing properties fit for the purpose.

### DESCRIPTION OF THE RELATED ART

Since hydraulic materials give cured substances excelling in strength and durability, they have been widely used in a cement composition including cement paste, mortar, and concrete and have become indispensable for the construction of civil engineering and constructional structures. The hydraulic materials of this quality, after being cured, incur dispersion of an unaltered water component remaining therein owing to an atmospheric temperature and humidity and suffer the drying shrinkage ascribable thereto to proceed. Thus, in the case of a reinforced concrete building, for example, after the concrete hardens, the concrete building is gradually shrunken due to drying. Since the steel reinforcement induces no such change of shape, strain occurs between the concrete building and the steel reinforcement and incurs crack on the surface of the concrete building. This crack not only impairs the appearance of the building but also induces the inclusion of air (particularly carbon dioxide gas) and rainwater (particularly acid and chloride ions) through the cracked part, eventual neutralization of concrete, and corrosion of steel reinforcement, over a long period, and as a result, seriously degrades the durability. When the durability of the civil engineering and building structures is degraded, there are serious problems such as decline of safety and increased cost for repair. In recent years, since the concrete buildings excelling in durability have been gaining in popularity, the importance of decreasing the drying shrinkage occurring in the concrete buildings such as civil engineering and constructional structures due to drying and repressing the generation of a crack on a surface of a cured concrete product has been finding recognition. The technical innovations therefor have been actively pursued.

For the purpose of reducing or repressing the drying shrinkage of a cement composition such as a concrete, a method for compensating the shrinkage by the use of an expanding agent and a method using a drying shrinkage-reducing agent have been available. The method of using an expanding agent incurs difficulty in adjusting the amount thereof to be added. If the amount is unduly small, the shortage would possibly prevent sufficient reducing effects from being attained. Conversely, if the amount is unduly large, the excess would possibility result in enlarging a crack in consequence of expansion. Various compounds have been now used as a drying shrinkage-reducing agent. JP-A 2001-247,346, for example, discloses a polymer formed by graft polymerizing an ethylenically unsaturated carboxylic acid with an alkoxy polyalkylene glycol.

### DISCLOSURE OF INVENTION

The drying shrinkage-reducing agent disclosed in JP-A 2001-247,346, however, has dispersibility. When such a drying shrinkage-reducing agent is used in an increased amount so as to attain desired drying shrinkage-reducing property, therefore, it manifests dispersibility in excess, and thus a problem arises that a desired drying shrinkage-reducing effect can be obtained with much difficulties.

This invention has been attained in consideration of the situations as mentioned above and has an object to provide a drying shrinkage-reducing agent which can manifest outstanding drying shrinkage-reducing ability. The expression “drying shrinkage-reducing agent” as used herein is referred to as an agent capable of repressing the shrinkage of a hydraulic material due to drying.

This invention has another object to provide a drying shrinkage-reducing agent which has no dispersibility in an amount capable of attaining necessary drying shrinking-reducing properties and, when used in combination with a dispersing agent, acquires an ability to adjust the dispersibility and the drying shrinkage-reducing properties fit for the purpose.

The present inventors, while continuing a diligent study with the object of solving the problems mentioned above and with a particular attention directed toward the surface tension with respect to water, have found that a drying shrinkage-reducing agent for a hydraulic material containing a structural unit having a hydrophobic group as an essential component and manifesting a specific surface tension, particularly a drying shrinkage-reducing agent for a hydraulic material containing a polymer having a specific structure, can manifest excellent drying shrinkage-reducing properties, does not manifest dispersibility even by an increase in the used amount, and when used in combination with a dispersing agent, acquires an ability to easily adjust the dispersibility and drying shrinkage-reducing properties fit for the purpose.

Specifically, the objects mentioned above can be accomplished by a drying shrinkage-reducing agent which comprises a polymer containing as an essential component at least one structural unit (I) represented by the following formula (1): 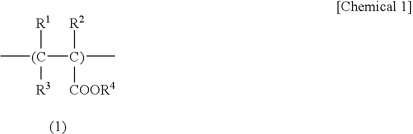
wherein R¹, R², and R³ independently stand for a hydrogen atom, a methyl group, or a —(CH₂)ₚCOOX group, wherein X stands for a hydrogen atom, a monovalent metal, a divalent metal, an ammonium group, an organic amine group, or a hydrocarbon group, and p is an integer of 0-2; and R⁴ stands for a hydrocarbon group of 4-30 carbon atoms,
and exhibiting surface tension in the range of 25-50 mN/m in a solution containing 0.2 mass % of the polymer in a cement supernatant.

In this invention, the polymer preferably contains as essential components at least one structural unit (I) represented by the formula (1) mentioned above; and at least one structural unit (II) selected among a structural unit (II-a) represented by the following formula (2): 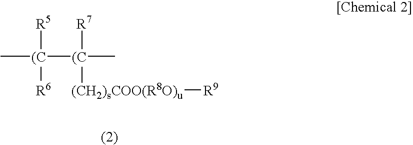
wherein R⁵, R⁶ and R⁷ independently stand for a hydrogen atom or a methyl group; s is an integer of 0-2; R⁸O stands for one oxyalkylene group of 2-18 carbon atoms or a mixture of two or more such oxyalkylene groups; u stands for an average addition mol number of oxyalkylene group (R⁸O) and is in the range of 1-300; and R⁹ stands for a hydrogen atom or a hydrocarbon group of 1-30 carbon atoms,
and a structural unit (II-b) represented by the following formula (3): 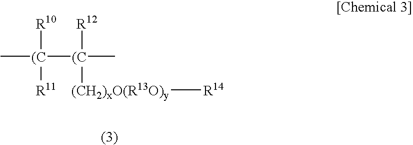
wherein R¹⁰, R¹¹ and R¹² independently stand for a hydrogen atom or a methyl group; x is an integer of 0-2; R¹³O stands for one oxyalkylele group of 2-18 carbon atoms or a mixture or two or more such groups; y stands for an average addition mol number of the oxyalkylene group (R¹³O) and is in the range of 1-300; and R¹⁴ stands for a hydrogen atom or a hydrocarbon group of 1-30 carbon atoms,
and contains at least one structural unit (III) represented by the following formula (4): 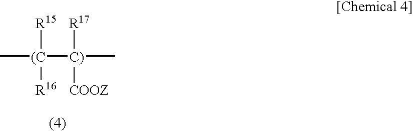
wherein R¹⁵, R¹⁶ and R¹⁷ independently stand for a hydrogen atom, a methyl group, or a —(CH₂)_{q}COOZ′, wherein Z′ stands for a hydrogen atom, a monovalent metal, a divalent metal, an ammonium group, or an organic amine group, and q is an integer of 0-2; and Z stands for a hydrogen atom, a monovalent metal, a divalent metal, an ammonium group, or an organic amine group, provided that if COOZ′ and COOZ are present in the total number of not less than 2, two of them may form an anhydride, in a proportion in the range of 0-30 mass % based on the total mass of the polymer.

The objects mentioned above can be also accomplished by a shrinkage-reducing composition which contains at least one drying shrinkage-reducing agent of this invention and a dispersing agent.

The drying shrinkage-reducing agent for a hydraulic material of this invention is characterized by comprising a polymer containing at least one structural unit (I) represented by the aforementioned formula (1) and exhibiting surface tension in the range of 25-50 mN/m in a solution containing 0.2 mass % of the polymer in a cement supernatant. Since such a polymer can significantly lower the surface tension of water, it can effectively repress the shrinkage of a cured cement product and manifest outstanding drying shrinkage-reducing properties. Further, the drying shrinkage-reducing agent of this invention preferably comprises a polymer which contains as essential components (A) at least one structural unit (I) represented by the aforementioned formula (1) and (B) at least one structural unit (II) selected among the structural unit (II-a) represented by the above formula (2) and the structural unit (II-b) represented by the above formula (3); and further contains (C) at least one structural unit (III) represented by the above formula (4) in a proportion in the range of 0-30 mass % based on the total mass of the polymer. Such a polymer used in an amount proper for obtaining a necessary drying shrinkage property manifests no dispersibility. Thus, the drying shrinkage-reducing agent containing this polymer, when used in combination with a dispersing agent, permits easy adjustment of a drying shrinkage-reducing property and dispersibility fit for the purpose.

The drying shrinkage-reducing agent of this invention, therefore, when applied to such hydraulic materials as cement paste, mortar, and concrete, to manifest outstanding crack-repressing effects, can enhance the durability of a cured product, exalt the safety of civil engineering and constructional structures, repress the cost of repair, and enjoy prominent general-purpose properties.

The above and other objects, features and advantages of the present invention will become clear from the following description of the preferred embodiments and illustrated in the attached drawings.

### BEST MODE FOR CARRYING OUT THE INVENTION

Now, the modes for carrying out the invention will be described in detail below.

The first aspect of this invention is to provide a drying shrinkage-reducing agent which comprises a polymer containing as an essential component at least one structural unit (I) (occasionally referred to simply as “structural unit (I) in the specification) represented by the following formula (1): 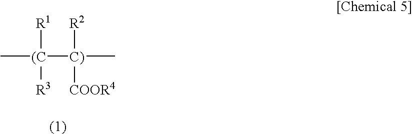
and exhibiting surface tension in the range of 25-50 mN/m in a solution containing 0.2 mass % of the polymer in a cement supernatant (occasionally referred to simply as “surface tension” in the specification). Though the definite mechanism for enabling the polymer to repress drying shrinkage in this invention has not been elucidated, the repression of the drying shrinkage by the polymer in this invention may be logically explained by the following supposition. To be specific, the drying shrinkage is caused by the tensile stress exerted on the interface between water in a capillary and a cured product by water when the water moves through the capillary in the cured cement product in consequence of drying. The polymer according to this invention is considered to derive from the introduction of the hydrophobic group of R⁴ in the structural unit (I) the ability to lower the interfacial tension between the cured cement product and the water, reduce the tensile stress of water which causes the drying shrinkage, and consequently repress the drying shrinkage. The polymer, in addition to the structural unit (I), preferably contains as essential components at least one structural unit (II) selected among the structural unit (II-a) (occasionally referred to briefly as “structural unit (II-a)” in the specification) represented by the following formula (2): 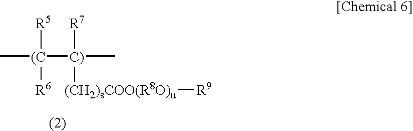
and the structural unit (II-b) (occasionally referred to briefly as “structural unit (II-b)” in the specification) represented by the following formula (3): 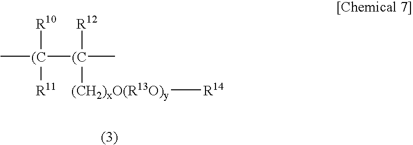
and further contains at least one structural unit (III) (occasionally referred to simply as “structural unit (III)” in the specification) represented by the following formula (4): 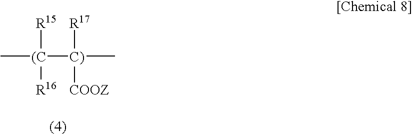
in a proportion in the range of 0-30 mass % based on the total mass of the polymer. Though the definite mechanism for the polymer mentioned above to repress the drying shrinkage has not been elucidated either, the repression of the drying shrinkage attained by the polymer according to this invention may be logically explained by the following presumption. Besides the function by the structural unit (I) of the polymer in this invention, particularly by incorporating in the polymer the structural unit (III) acting so as to manifest dispersibility in such a low proportion as of 0-30 mass % based on the total mass of the polymer, the polymer can manifest water-solubility without showing dispersibility and, the combined use with a dispersing agent permits easy adjustment of dispersibility and drying shrinkage-reducing properties proper for the purpose. If the structural unit (III) is present in the polymer at a proportion exceeding 30 mass %, this overage would possibly result in incorporating an excess amount of acid into the polymer, suffering the formed polymer to be adsorbed on cement and eventually manifest dispersibility, and further inducing such problems as retarding the hardening of cement. In the structural units mentioned above, the structural unit (II) may function to impart water-solubility to the polymer. The drying shrinkage-reducing agent of this invention, therefore, can be advantageously used in various portland cements including ordinary, high-early-strength, moderate heat, low heat, and sulfate resistant, hydraulic cements such as Blite-rich cement, calcium-aluminate cement, portland blast furnace slag cement, portland fly-ash cement, and various blended cements, or other hydraulic materials than cement such as gypsum for the purpose of effectively reducing drying shrinkage.

The polymer according to this invention contains the structural unit (I) as an essential component and essentially exhibits surface tension in the range of 25-50 mN/m in a solution containing 0.2 mass % of the polymer in a cement supernatant. When the surface tension falls in this range, the polymer satisfy fully practicability on a commercial scale and can effectively repress the shrinkage of cement in a cured state. When this polymer is used on such a structure as steel reinforcement which induces no change of shape with time, therefore, any strain would not induced between itself and the cured cement product and thus there would be no problems as of cracking. If the surface tension of the polymer exceeds 50 mN/m, sufficient shrinkage-reducing effects cannot be attained. If such a polymer is used in steel reinforcement, for example, the cured cement product would shrink, to induce strain between the steel reinforcement and the cured cement product, and eventually entail the phenomenon of cracking. While this invention prefers the surface tension to be as low as permissible, it sets the lower limit of the surface tension at 25 mN/M in due consideration of the practicability on the commercial scale. In this invention, the surface tension of the polymer in a solution containing 0.2 mass % of the polymer in a cement supernatant is preferably in the range of 25-46 mN/m, more preferably in the range of 25-42 mN/m, and particularly preferably in the range of 25-38 mN/m.

In the present specification, the “surface tension in a solution containing 0.2 mass % of a polymer in a cement supernatant” is referred to as a value determined in accordance with the following procedure under the following conditions.

<Conditions for Determination>

Instrument for determination: Made by BYK-Chemie and sold under the Product Name of “Dynometer.”

Ring: Made of platinum in a diameter of 19.5 mm

Standard solution: Purified water, 72.8 mN/m (20° C.)

Table speed: 1.5 mm/min.

Measuring temperature: 20° C.

<Procedure of Determination>

In a glass beaker having an inner volume of 300 ml and holding a stirrer chip 39 mm in length, 200 mass parts of deionized water at 25° C. is placed and kept stirred with a magnetic stirrer. Then, 100 mass parts of ordinary portland cement made by Taiheiyo Cement K.K. adjusted in advance in an atmosphere at 25° C. is thrown into the stirred deionized water. After this introduction, the stirring at a rotational frequency of 700 rpm is continued for 30 minutes so as to induce satisfactory separation of the water-soluble component in the cement particles into water and the stirred mixture is then left standing for 10 minutes. The resultant supernatant is filtered by suction with a filter paper (made by Advantech Toyo K.K., fixed quantity filter paper 5C). The filtrate is further filtered with a water type filter having a pore diameter of 0.45 μm (Chromatodisk 25A, made by Kurabo K.K. and sold by G.L. Science), to obtain an aqueous supernatant. The cement supernatant thus prepared is placed in a container, sealed with nitrogen therein, and stored in a tightly sealed state.

Separately, an aqueous solution having a solid content of 5 mass % is prepared by adding a deionized water at 25° C. to a drying shrinkage-reducing agent of this invention or a copolymer for comparison. By adding 5 mass parts of the aqueous solution containing the drying shrinkage-reducing agent of this invention or the copolymer for comparison and 120 mass parts of the aforementioned cement supernatant together and thoroughly mixing them, the aqueous 0.2 mass % sample solution is prepared. This aqueous sample solution is placed in a container, sealed with nitrogen therein, tightly stoppered, and adjusted to 20° C.

Next, the platinum ring in a thoroughly cleaned state is mounted on the Dynometer and submerged to a depth of 3 mm in the standard solution (purified water) adjusted in advance at 20° C. The table holding this standard solution is lowered at a speed of 1.5 mm/min. At this time, the point at which the reading of the Dynometer reaches the maximum is calibrated as the surface tension of water. Next, the thoroughly cleaned platinum ring is submerged to a depth of 3 mm in the sample solution adjusted in advance at 20° C. and the table holding the aqueous solution thereon is lowered at a speed of 1.5 mm/min. The point at which the reading of the Dynometer reaches the maximum is reported as the surface tension of the drying shrinkage-reducing agent of this invention or the copolymer for comparison.

In the formula (1), R¹, R², and R³ stand for a hydrogen atom, a methyl group, or a —(CH₂)ₚCOOX group, preferably a hydrogen atom or a methyl group. In this case, R¹, R², and R³ may be identical or different from each other. Then, in the formula: (CH₂)ₚCOOX, X stands for a hydrogen atom, a monovalent metal, a divalent metal, an ammonium group (—NH₂), an organic amine group, or a hydrocarbon group. In this case, as typical examples of the monovalent metal, lithium, sodium, and potassium may be cited. As typical examples of the divalent metal, magnesium, calcium, strontium, and barium may be cited. Incidentally, when X is a divalent metal, it assumes the form of an anhydride with two —COO—'s. As typical examples of the organic amine group, groups from such primary amines as methyl amine, ethyl amine, propyl amine, n-butyl amine, sec-butyl amine, tert-butyl amine, cyclohexyl amine, benzyl amine, and phenyl amine; groups from such secondary amines as dimethyl amine, diethyl amine, dipropyl amine, dibutyl amine, diisobutyl amine, di-sec-butyl amine, di-tert-butyl amine, dicyclohexyl amine, dibenzyl amine, and diphenyl amine; groups from such tertiary amines as trimethyl amine, triethyl amine, tripropyl amine, tributyl amine, tricyclohexyl amine, tribenzyl amine, and triphenyl amine; and groups from such alkanol amines as ethanol amine, diethanol amine, and triethanol amine may be cited. Among other organic amine groups cited above, the alkanol amine groups such as ethanol amine group, diethanol amine group, and triethanol amine group and the triethyl amine group prove particularly advantageous. The hydrocarbon group, for example, is a hydrocarbon group preferably of 1-30 carbon atoms, more preferably of 1-20 carbon atoms, and particularly preferably of 1-12 carbon atoms. As typical examples of the hydrocarbon group of 1-30 carbon atoms, linear or branched alkyl groups such as methyl, ethyl, propyl, isopropyl, n-butyl, isobutyl, sec-butyl, tert-butyl, pentyl, isopentyl, neopentyl, hexyl, heptyl, octyl, nonyl, decyl, undecyl, dodecyl, isooctyl, 2,3,5-trimethylhexyl, 4-ethyl-5-methyloctyl, and 2-ethylhexyl, tetradecyl, octadecyl, and isocyl; cyclicalkyl groups such as cyclopropyl, cyclobutyl, cyclopentyl, cyclohexyl, cycloheptyl, and cyclooctyl; and aryl groups such as phenyl, benzyl, phenethyl, o-, m-, or p-tolyl, 2,3- or 2,4-xylyl, mesityl, naphthyl, antholyl, phenanthryl, biphenylyl, benzhydryl, trithyl, and pyrenyl may be cited. X preferably stands for a hydrogen atom, a monovalent metal, a divalent metal, an ammonium group, or an organic amine group and particularly a hydrogen atom, sodium, or calcium. In the above formula (1), p is an integer of 0-2, preferably 0 or 1, and particularly 0. Then, R⁴ stands for a hydrocarbon group of 4-30 carbon atoms. If the number of carbon atoms of R⁴ is not more than 3, the shortage would not result in attaining drying shrinkage-reducing properties aimed at. Conversely, if this number exceeds 31, the overage would result in disrupting the balance between hydrophilicity and hydrophobicity of the polymer. Thus, the carbon atom number preferably falls in the range of 4-30. The carbon atom number of R⁴ is preferably in the range of 4-30, more preferably in the range of 4-18, and still more preferably in the range of 4-12, and most preferably in the range of 5-12. As typical examples of the hydrocarbon group, linear and branched alkyl groups such as butyl, isobutyl, sec-butyl, tert-butyl, pentyl, isopentyl, neopentyl, hexyl, heptyl, octyl, nonyl, decyl, undecyl, dodecyl, isooctyl, 2,3,5-trimethylhexyl, 4-ethyl-5-methyloctyl and 2-ethylhexyl, tetradecyl, octadecyl, and icosyl; cyclic alkyl groups such as cyclopentyl, cyclohexyl, cycloheptyl, and cyclooctyl; and aryl groups such as phenyl, benzyl, phenethyl, o-, m-, or p-tolyl, 2,3- or 2,4-xylyl, mesityl, naphthyl, anthryl, phenanthryl, biphenyl, benzhydryl, trityl, and pyrenyl may be cited. Among other hydrocarbon groups cited above, the alkyl groups such as butyl, isobutyl, sec-butyl, tert-butyl, pentyl, isopentyl, neopentyl, hexyl, heptyl, octyl, nonyl, decyl, undecyl, dodecyl, isooctyl, 2,3,5-trimethylhexyl, 4-ethyl-5-methyloctyl, and 2-ethylhexyl which have 4-12 carbon atoms prove particularly advantageous in consideration of the dispersibility of a cured cement product and the drying shrinkage-reducing properties of a cured cement product.

As typical examples of the monomer which introduces the structural unit (I) into the polymer in this invention (occasionally referred to briefly as “monomer (a)” hereinafter), ester compounds of a monool of 4-30 carbon atoms, namely saturated aliphatic alcohols of 4-30 carbon atoms such as butanol, isobutanol, sec-butanol, tert-butanol, 1-pentanol, 1-hexanol, octanol, 1-ethyl-1-hexanol, nonyl alcohol, lauryl alcohol, cetyl alcohol, and stearyl alcohol; unsaturated aliphatic alcohols of 4-30 carbon atoms such as oleyl alcohol, alicyclic alcohols of 4-30 carbon atoms such as cyclohexanol, and aromatic alcohols of 6-30 carbon atoms such as phenol, phenyl methanol (benzyl alcohol), methyl phenol (cresol), p-ethyl phenol, dimethyl phenol (xylenol), p-t-butyl phenol, nonyl phenol, dodecyl phenol, phenyl phenol, and naphthol, with an unsaturated monocarboxylic acid such as (meth)acrylic acid and crotonic acid or unsaturated dicarboxylic acids such as maleic acid, itaconic acid, citraconic acid, and fumaric acid may be cited. When R¹, R², and R³ independently stand for a hydrogen atom or a methyl group, the ester compounds of the aforementioned alcohol of 4-30 carbon atoms with such an unsaturated monocarboxylic acid as (meth) acrylic acid and crotonic acid may be favorably used as the monomer (a) from the viewpoint of the copolymerizing property with a monomer which introduces the structural unit (II) which will be described specifically herein below. As typical examples of the monomer (a) which has the structural unit (I) of the formula (1) wherein at least one of R¹, R², and R³ stands for a —(CH₂)ₚCOOX group and X stands for a hydrogen atom, a uniivalent metal, a divalent metal, an ammonium group, or an organic amine group, such unsaturated monocarboxylic acid type monomers as acrylic acid, methacrylic acid, crotonic acid, and metal salts, ammonium salts, and amine salts thereof may be cited. As typical examples of the unsaturated dicarboxylic acid type monomer, maleic acid, itaconic acid, citraconic acid, fumaric acid, or metal salts, ammonium salts, and amine salts thereof may be cited. As typical examples of the anhydride thereof, maleic anhydride, itaconic anhydride, and citraconic anhydride may be cited. Among other monomers cited above, the unsaturated monocarbocylic acid type monomers prove favorable and (meth)acrylic acid and salts thereof prove particularly favorable. The monomers (a) cited above may be used either singly or in the form of a mixture of two or more members.

As typical examples of the monomer (a), various alkyl (meth)acrylates such as butyl (meth)acrylate, isobutyl (meth)acrylate, sec-butyl (meth)acrylate, tert-butyl (meth)acrylate, 1-pentyl (meth)acrylate, 1-hexyl (meth)acrylate, 1-octyl (meth)acrylate, 2-ethylhexyl (meth)acrylate, lauryl (meth)acrylate, cetyl (meth)acrylate, stearyl (meth)acrylate, cyclohexyl (meth)acrylate, and benzyl (meth)acrylate; various alkyl maleates such as (di)propylmaleate, (di)butylmaleate, and (di)-2-ethylhexyl maleate; and various alkyl fumarates such as (di)propyl fumarate, (di)butyl fumarate, and (di)-2-ethylhexyl fumarate may be cited. In this case, these monomers (a) or the structural units (I) may be used either singly or in the form of a mixture of two or more members.

In the above formula (2), R⁵, R⁶, and R⁷ stand for a hydrogen atom or a methyl group and preferably at least either of R⁵ and R⁶ stands for a hydrogen atom. In this case, R⁵, R⁶, and R⁷ may be identical or different from each other. Then, s is an integer of 0-2, preferably 0 or 1, and more preferably 0. R⁸O stands for an oxyalkylene group of 2-18 carbon atoms, preferably an oxyalkylene group of 2-8 carbon atoms, and more preferably an oxyalkylene group of 2-4 carbon atoms. As typical examples of the oxyalkylene group, oxyethylene group, oxypropylene group, oxybutylene group, oxyisobutylene group, oxy-1-butene group, oxy-2-butene group, and oxystyrene group may be cited. Oxyethylene group, oxypropylene group, and oxybutylene group are preferable, and oxyethylene group and oxypropylene group are more preferable. When a plurality of such oxyalkylene groups are present in one structural unit (namely when n is not less than 2 in the formula (2)), the oxyalkylene groups may be present either singly or in the form of a mixture of two or more members in one structural unit. When two or more oxyalkylene groups are present, the form of their addition may be in any such additions as random addition, block addition, and alternating addition. When one kind of structural unit is used alone as the structural unit (II-a), the oxyalkylene group preferably contains an oxyethylene group as an essential component for the purpose of securing the balance between hydrophilicity and hydrophobicity. More preferably, the oxyethylene group accounts for not less than 50 mol % of the oxyalkylene group.

In the above formula (2), u stands for an average addition mol number of the oxyalkylene group (R⁸O), and is in the range of 1-300. If u exceeds 300, the produced polymer would manifest dispersibility, preclude its own incorporation in a necessary amount, and render difficult the acquisition drying shrinkage-reducing properties aimed at. Further, when u exceeds 300, the excess would result in exalting air entraining property, rendering difficult the adjustment of the air content, and inducing degradation of strength and deterioration of the resistance to freezing and melting. In this case, u is preferably in the range of 1-150, 1-100, 1-80, 1-50, and 1-30 in this order. R⁹ stands for a hydrogen atom or a hydrocarbon group of 1-30 carbon atoms. Preferably, it stands for a hydrogen atom or a hydrocarbon group of 1-20 carbon atoms. More preferably, it stands for a hydrogen atom or a hydrocarbon group of 1-18 carbon atoms. Particularly preferably, it stands for a hydrogen atom or a hydrocarbon group of 1-12 carbon atoms. As typical examples of the hydrocarbon group, linear or branched alkyl groups such as methyl group, ethyl group, propyl group, isopropyl group, n-butyl group, isobutyl group, sec-butyl group, tert-butyl group, pentyl group, isopentyl group, neopentyl group, hexyl group, heptyl group, octyl group, nonyl group, decyl group, undecyl group, dodecyl group, isooctyl group, 2,3,5-trimethylhexyl group, 4-ethyl-5-methyloctyl group and 2-ethylhexyl group, tetradecyl group, octadecyl group, and icosyl group; cyclic alkyl groups such as cyclopropyl, cyclobutyl, cyclopentyl, cyclohexyl, cycloheptyl, and cyclooctyl; and aryl groups such as phenyl group, benzyl group, phenetyl group, o-, m-, or p-tolyl group, 2,3- or 2,4-xylyl group, mesityl group, naphthyl group, anthryl group, phenanthryl group, biphenylyl group, benzhydryl group, trityl group, and pyrenyl group may be cited.

As typical examples of the monomer which introduces the structural unit (II-a) into the polymer in this invention (occasionally referred to briefly as “monomer (b)” hereinafter), adducts of alkylene oxides of 2-18 carbon atoms to the products by dehydration (oxidation) of (meth)acrylic acid, crotonic acid, or a fatty acid, or ester compounds of (meth)acrylic acid or crotonic acid with an alkoxypolyalkylene glycol obtained by adding alkylene oxides of 2-18 carbon atoms to either a saturated aliphatic alcohol of 1-30 carbon atoms such as methanol, ethanol, 2-propanol, 1-butanol, 1-pentanol, 1-hexanol, octanol, 2-ethyl-1-hexanol, nonyl alcohol, lauryl alcohol, cetyl alcohol, and stearyl alcohol, an unsaturated aliphaatic alcohols of 3-30 carbon atoms such as allyl alcohol, methallyl alcohol, crotyl alcohol, and oleyl alcohol, an alicyclic alcohol of 3-30 carbon atoms such as cyclohexanol, or an aromatic alcohol of 6-30 carbon atoms such as phenol, phenyl methanol (benzyl alcohol), methyl phenol (cresol), p-ethyl phenol, dimethyl phenol (xylenol), p-t-butyl phenol, nonyl phenol, dodecyl phenol, phenyl phenol, and naphthol may be cited. Among other monomers cited above, the ester compounds of (meth)acrylic acid or crotonic acid and corresponding alkoxypolyalkylene glycol which answer the formula (2) on the condition that R⁹ happen to be a hydrocarbon group prove particularly advantageous. The monomers (b) mentioned above may be used either singly or in the form of a mixture of two or more members.

As typical examples of the monomer (b), various alkoxypolyethylene glycol mono(meth)acrylates such as hydroxymethyl(meth)acrylate, hydroxyethyl (meth)acrylate, hydroxypropyl (meth)acrylate, methoxypolyethylene glycol mono(meth)acrylate, ethoxypolyethylene glycol mono(meth)acrylate, 1-propoxypolyethylene glycol mono(meth)acrylate, 2-propoxypoly-ethylene glycol mono(meth)acrylate, 1-butoxypolyethylene glycol mono(meth)acrylate, 2-butoxypolyethylene glycol mono(meth)acrylate, 2-methyl-1-propoxypolyethylene glycol mono(meth)acrylate, 2-methyl-2-propoxypolyethyleneglycol mono(meth)acrylate, 1-pentyloxypolyethylene glycol mono(meth)acrylate, 1-hexyloxypolyethylene glycol mono(meth)acrylate, cyclohexyloxypolyethylene glycol mono(meth)acrylate, 1-octyloxypolyethylene glycol mono(meth)acrylate, 2-ethyl-1-hexyloxypolyethylene glycol mono(meth)acrylate, nonylalkoxypolyethylene glycol mono(meth)acrylate, lauryl alkoxypolyethylene glycol mono(meth)acrylate, cetyl alokoxypolyethylene glycol mono(meth)acrylate, stearyl alkoxypolyethylene glycol mono(meth)acrylate, phenoxypolyethylene glycol mono(meth)acrylate, phenylmethoxypolyethylene glycol mono(meth)acrylate, methylphenoxypolyethylene glycol mono(meth)acrylate, p-ethylphenoxypolyethylene glycol mono(meth)acrylate, dimethylphenoxypolyethylene glycol mono(meth)acrylate, p-t-butylphenoxypoly-ethylene glycol mono(meth)acrylate, nonylphenoxypolyethyleneglycol mono(meth)acrylate, dodecylphenoxypolyethylene glycol mono(meth)acrylate, phenylphenoxypolyethylene glycol mono(meth)acrylate, naphthoxypolyethylene glycol mono(meth)acrylate, esters of (meth)allyl alcohol having ethylene oxide added with (meth)acrylic acid, and esters of crotyl alcohol having ethylene oxide added with (meth) acrylic acid; various alkoxypolypropylene glycol mono(meth)acrylates such as methoxypolypropylene glycol mono(meth)acrylate, ethoxypolypropylene glycol mono(meth)acrylate, 1-propoxypolypropylene glycol mono(meth)acrylate, 2-propoxypolypropylene glycol mono(meth)acrylate, 1-butoxypolypropyleneglycol mono(meth)acrylate, esters of propylene oxide-added (meth)allyl alcohol and (meth)acrylic acid, and ester of propylene oxide-added crotyl alcohol and (meth)acrylic acid; various alkoxypolyalkylene glycol mono (meth)acrylates such as methoxypolyethylenepolypropylene glycol mono (meth)acrylate, methoxypolyethylenepolybutylene glycol mono (meth)acrylate, ethoxypolyethylenepolypropylene glycol mono(meth)acrylate, ethoxypolyethylenepolybutylene glycol mono(meth)acrylate, 1-propoxypolyethylenepolypropylene glycol mono(meth)acrylate, 1-propoxypolyethylenepolybutylene glycol mono(meth)acrylate, 2-propoxypolyethylenepolypropylene glycol mono(meth)acrylate, 2-propoxypolyethylenepolybutylene glycol mono(meth)acrylate, 1-butoxypolyethylenepolypropylene glycol mono(meth)acrylate, 1-butoxypolyethylenepolybutylene glycol mono (meth)acrylate, and esters of alcohol having at least two alkylene oxides added with (meth)acrylic acid such as esters of (meth)allyl alcohol having ethylene oxide and propylene oxide added with (meth)acrylic acid, and esters of crotyl alcohol having ethylene oxide, propylene oxide and butylene oxide added with (meth)acrylic acid may be cited. In this case, these monomers (b) or structural units (II-a) may be used either singly or in the form of a combination of two or more members.

In the formula (3), R¹⁰, R¹¹ and R¹² stand for a hydrogen atom or a methyl group and preferably at least either of R¹⁰ or R¹¹ stands for a hydrogen atom. In this case, R¹⁰, R¹¹, and R¹² may be identical or different from each other. x is an integer of 0-2, preferably 0 or 1, and more preferably 0. R¹³O stands for an oxyalkylene group of 2-18 carbon atoms, preferably an oxyalkylene group carbon atoms of 2-8 carbon atoms, and more preferably an oxyalkylene group of 2-4 carbon atoms. The oxyalkylene group in this case is as defined for R⁸O in the formula (2). When a plurality of such oxyalkylene groups are present in one structural unit (namely when n is not less than 2 in the formula (3)), the oxyalkylene groups may be present either singly or in the form of a mixture of two or more members in one structural unit. When two or more oxyalkylene groups are present, the form of their addition may be in any such additions as random addition, block addition, and alternating addition. When one kind of structural unit is used alone as the structural unit (II-b), the oxyalkylene group preferably contains an oxyethylene group as an essential component for the purpose of securing the balance between hydrophilicity and hydrophobicity. More preferably, the oxyethylene group accounts for not less than 50 mol % of the oxyalkylene group. y stands for an average addition mol number of the oxyalkylene group (R¹³O) and is in the range of 1-300. If y exceeds 300, the produced polymer would manifest dispersibility, preclude its own incorporation in a necessary amount, and render difficult the acquisition drying shrinkage-reducing properties aimed at. Further, when y exceeds 300, the excess would result in exalting air entraining property, rendering difficult the adjustment of the air content, and inducing degradation of strength and deterioration of the resistance to freezing and melting. In this case, y is preferably in the range of 1-150, 1-100, 1-80, 1-50, and 1-30 in this order. R¹⁴ stands for a hydrogen atom or a hydrocarbon group of 1-30 carbon atoms, preferably a hydrogen atom or a hydrocarbon group of 1-20 carbon atoms, more preferably a hydrogen atom or a hydrocarbon group of 1-18 carbon atoms, and particularly preferably a hydrocarbon group of 1-12 carbon atoms. Since the substituent “R¹⁴” in the formula (3) is as defined for the substituent “R⁹” in the formula (2), the description thereof will be omitted herein.

The monomer which introduces the structural unit (II-b) into the polymer in this invention (occasionally referred to briefly as “monomer (c)” hereinafter) include the adducts of alkylene oxides of 2-18 carbon atoms to such alcohols as vinyl alcohol and isoprene alcohol, for example. The monomers (c) mentioned above may be used either singly or in the form of a mixture of two or more members.

As typical examples of the monomer (c), (poly) ethylene glycol-3-methyl-3-butenyl ether, (poly)propylene glycol-3-methyl-3-butenyl ether, (poly)butylene glycol-3-methyl-3-butenyl ether, (poly)ethylene glycol (poly)propylene glycol-3-methyl-3-butenyl ether, and (poly)ethylene glycol (poly)butylene glycol-3-methyl-3-butenyl ether may be cited. In this case, these monomers (c) or structural units (II-b) may be used either singly or in the form of a combination of two or more members.

In the formula (4), R¹⁵, R¹⁶, and R¹⁷ stand for a hydrogen atom, a methyl group, or a —(CH₂)_{q}COOZ′ group. In this case, R¹⁵, R¹⁶, and R¹⁷ may be identical or different from each other. Z′ stands for a hydrogen atom, a monovalent metal, a divalent metal, an ammonium group, or an organic amine group. Then, q is an integer of 0-2, preferably 0 or 1, and particularly 0. Z stands for a hydrogen atom, a monovalent metal, a divalent metal, an ammonium group, or an organic amino group. In this case, the substituents “Z” and “Z′” are as defined for the substituent “X” in the formula (1) except they do not stand for a hydrocarbon group. When two or three COOZ′ groups are present, the COOZ′ groups may be identical or different from each other. When the groups COOZ′ and COOZ are present in the total number of not less than 2, two of them may form an anhydride.

As typical examples of the monomer which introduces the structural unit (III) into the polymer in this invention (occasionally referred to briefly as “monomer (d)” hereinafter), such unsaturated monocarboxylic acid type monomers as acrylic acid, methacrylic acid, crotonic acid, and metal salts, ammonium salts, and amine salts thereof may be cited. As typical examples of the unsaturated dicarboxylic acid type monomers, maleic acid, itaconic acid, citraconic acid, fumaric acid, and metal salts, ammonium salts, and amine salts thereof may be cited. As typical examples of the anhydrides thereof, maleic anhydride, itaconic anhydride, and citraconic anhydride may be cited. Among other monomers cited above, unsaturated monocarboxylic acid type monomers wherein R¹⁵, R¹⁶, and R¹⁷ independently stand for a hydrogen atom or a methyl group prove advantageous and (meth)acrylic acids and salts thereof prove particularly favorable. In this case, these monomers (d) or structural units (III) may be used either singly or in the form of a combination of two or more members.

The polymer according to this invention contains a structural unit (I) and a structural unit (II-a) and/or a structural unit (II-b) as essential structural units and contains a structural unit (III) in a proportion in the range of 0-30 mass % based on the total mass of the polymer. In this case, each the structural units (I), (II-a), and (II-b) and the structural unit (III) may be either singly or in the form of a combination of two or more members. Further, the structural unit (I), the structural unit (II-a), the structural unit (II-b), and the structural unit (III) may be independently in a blocked form or a random form. The polymer according to this invention may contain at least one other structural unit (occasionally referred to briefly as “structural unit (IV)”). Even in this case, these structural units may be present in a blocked form or a random form.

The monomers which introduces the other structural unit (IV) to the polymer (occasionally referred to briefly as “monomer (e)” hereinafter) include monomers which are copolymerizable with the other monomer component, for example. As typical examples of the monomer, half esters and diesters of such unsaturated dicarboxylic acids as maleic acid, fumaric acid, itaconic acid, and citraconic acid with alcohols having 1-4 carbon atoms; half amides and diamides of the aforementioned unsaturated dicarboxylic acid with amines having 1-30 carbon atoms; half esters and diesters of alkyl (poly)alkylene glycols resulting from adding 1-500 mols of alkylene oxides having 2-18 carbon atoms to the aforementioned alcohols or amines with the aforementioned unsaturated dicarboxylic acids; half esters and diesters of the aforementioned unsaturated dicarboxylic acids with glycols having 2-18 carbon atoms or with polyalkylene glycols having these glycols in an addition mol number of 2-500; half amides of maleamic acid with glycols having 2-18 carbon atoms or with polyalkylene glycols having these glycols in an addition mol number of 2-500; (poly)alkylene glycol di(meth)acrylates such as triethylene glycol di(meth)acrylate, (poly)ethylene glycol di(meth)acrylate, polypropylene glycol di(meth)acrylate, and (poly)ethylene glycol (poly)propylene glycol di(meth)acrylate; bifunctional (meth)acrylates such as hexane diol di(meth)acrylate, trimethylol propane tri(meth)acrylate, and trimethylol propane di(meth)acrylate; (poly)alkylene glycol dimaleates such as triethylene glycol dimaleate and polyethylene glycol dimaleate; unsaturated sulfonic acids such as vinyl sulfonate, (meth)allyl sulfonate, 2-(meth)acryloxy ethyl sulfonae, 3-(meth)acryloxy propyl sulfonate, 3-(meth)acryloxy-2-hydroxypropyl sulfonate, 3-(meth)acryloxy-2-hydroxypropyl sulfophenylether, 3-(meth)acryloxy-2-hydroxypropyloxy sulfobenzoate, 4-(meth)acryloxybutyl sulfonate, (meth)acrylamide methylsulfonic acid, (meth)acrylamide ethyl sulfonic acid, 2-methylpropane sulfonic acid (meth)acrylamide, and styrene sulfonic acid, and monovalent metal salts, divalent metal salts, ammonium salts, and organic amine salts thereof; esters of such unsaturated monocarboxylic acids as methyl(meth)acrylate, ethyl(meth)acrylate, propyl(meth)acrylate, glycidyl(meth)acrylate, methyl crotonate, ethyl crotonate, and propyl crotonate with alcohols having 1-4 carbon atoms; amides of the unsaturated monocarboxylic acids with amines having 1-30 carbon atoms, like methyl (meth)acrylamides; vinyl aromatic compounds such as styrene, α-methyl styrene, vinyl toluene, and p-methyl styrene; alkane diol mono(meth)acrylates such as 1,4-butane diol mono (meth) acrylate, 1,5-pentane diol mono (meth) acrylate, and 1,6-hexane diol mono-(meth)acrylate; dienes such as butadiene, isoprene, 2-methyl-1,3-butadiene, and 2-chloro-1,3-butadiene; unsaturated amides such as (meth)acrylamide, (meth)acrylalkyl amide, N-methylol(meth)acrylamide, and N,N-dimethyl(meth)acrylamide; unsaturated cyanogens such as (meth)acrylonitrile and α-chloroacrylonitrile; unsaturated esters such as vinyl acetate and vinyl propionate; unsaturated amines such as aminoethyl(meth)acrylate, methyl aminoethyl(meth)acrylate, dimethyl aminoethyl(meth)acrylate, dimethyl aminopropyl(meth)acrylate, dibutyl aminoethyl(meth)acrylate, and vinyl pyridine; divinyl aromatic compounds such as divinyl benzene; cyanurates such as triallyl cyanurate; allyls such as (meth)allyl alcohol and glycidyl(meth)allyl ether; unsaturated amino compounds such as dimethylaminoethyl(meth)acrylate; vinyl ethers or allyl ethers such as methoxypolyethylene glycol monovinyl ether, polyethylene glycol monovinyl ether, methoxypolyethylene glycol mono(meth)allyl ether, and polyethylene glycol mono(meth)allyl ether; siloxane derivatives such as polydimethyl siloxane propylaminomalein amic acid, polydimethyl siloxane aminopropylene aminomalein amic acid, polydimethyl siloxane-bis-(propylaminomalein amic acid), polydimethyl siloxane-bis-(dipropylene aminomalein amic acid), polydimethyl siloxane-(1-propyl-3-acrylate), polydimethyl siloxane-(1-propyl-3-methacrylate), polydimethyl siloxane-bis-(1-propyl-3-acrylate), and polydimethyl siloxane-bis-(1-propyl-3-methacrylate); and unsaturated phosphates such as 2-acryloylloxy ethyl phosphate and 2-methacryloyloxy ethyl phosphate may be cited. In this case, these monomers (e) or structural units (IV) originating in the monomers (e) may be used either singly or in the form of a combination of two or more members.

The method for producing the polymer according to this invention does not need to be particularly restricted. Any of the known methods available for polymerization may be adopted. Generally, the monomer component mentioned above may be polymerized by the use of a polymerization initiator. The method for polymerizing the monomer components does not need to be particularly restricted. Any of the known method available for polymerization may be used similarly or as modified. The polymerization may be accomplished by polymerization in a solvent or by bulk polymerization, for example. The polymerization in a solvent may be carried out batchwise or continuously. As typical examples of the solvent which can be used in this case, water; lower alcohols such as methyl alcohol, ethyl alcohol, and 2-propanol; aromatic or aliphatic hydrocarbons such as benzene, toluene, xylene, cyclohexane, and n-hexane; ester compounds such as ethyl acetate; and ketone compounds such as acetone and methylethyl ketone may be cited. In consideration of the solubility of the monomer as the raw material and the polymer consequently produced and the convenience of the use of the produced polymer, it is preferable to use at least one member selected from the group consisting of water and lower alcohols of 1-4 carbon atoms, more preferable to use a lower alcohol of 1-4 carbon atoms. Methyl alcohol, ethyl alcohol, and 2-propanol are particularly usable.

The polymerization initiator to be used when the polymerization is performed in an aqueous medium does not need to be particularly restricted. Any of the known polymerization initiators may be used. Such water-soluble polymerization initiators as ammonium, a persulfate of an alkali metal, or hydrogen peroxide are available. In this case, the polymerization initiator may be used in combination with such a promoter as sodium hydrogen sulfite, Mohr's salt, ascorbic acid (the salt thereof), or Rongalite. The polymerization initiator to be used when the polymerization is performed in a lower alcohol, an aromatic hydrocarbon, an aliphatic hydrocarbon, an ester compound, or a ketone compound as a solvent does not need to be particularly restricted. Any of known polymerization initiators which are available may be used. Specifically, peroxides such as benzoyl peroxide and lauroyl peroxide; hydroperoxides such as cumene hydroperoxide; and azo compounds such as azobisisobutylonitrile, for example, can be used as the polymerization initiator. In this case, the polymerization initiator may be used in combination with such a promoter as an amine compound. When a mixed solvent of water with a lower alcohol is used, a proper combination may be selected from various possible combinations including the use of the polymerization initiators or the combined use of the polymerization initiators and the promoters. The amount of the polymerization initiator to be added does not need to be particularly restricted but may equal the amount to be used in any of the known methods of polymerization. Further, the conditions for the polymerization do not need to be particularly restricted but may equal those used in any of the known methods of polymerization. The polymerization temperature, for example, can be suitably decided depending on the kind of solvent and polymerization initiator to be used. Generally, it is in the range of 0-120° C.

In the case of bulk polymerization, the method to be used therefor, the kind and the amount of the polymerization initiator to be used, and the conditions for the polymerization do not need to be particularly restricted but may be selected from those of known methods. The polymerization initiators which are usable include peroxides such as benzoyl peroxide and lauroyl peroxide; hydroperoxides such as cumene hydroperoxide; and azo compounds such as azobisisobutylonitrile, for example. The bulk polymerization may be carried out at a temperature in the range of 50-200° C.

For the purpose of adjusting the molecular weight of the polymer to be obtained, it is permissible to use hypophosphorous acid (salt) or a thiol type chain transfer agent additionally. The thiol type chain transfer agent to be used in this case is represented by the formula: HS-R¹⁸-E_{g} (wherein R¹⁸ stands for an alkyl group of 1-2 carbon atoms and E stands for a —OH, —COOM, —COOR¹⁹, or SO₃M, and M stands for a hydrogen atom, a monovalent metal, a divalent metal, an ammonium group, or an organic amine group, R¹⁹ stands for an alkyl group of 1-10 carbon atoms, and g is an integer of 1-2). As typical examples of the thiol type chain transfer agent, mercapto ethanol, thioglycerol, thioglycolic acid, 2-mercaptopropionic acid, 3-mercaptopropionic acid, thiomalic acid, octyl thioglycolate, and octyl 3-mercaptopropionate may be cited. These chain transfer agents may be used either singly or in the form of a mixture of two or more members. Further, for the adjustment of the molecular weight of the polymer, it is effective to use as the monomer (e) a monomer such as (meth)allyl sulfonic acid (the salt thereof) having a high chain transferring ability.

The polymer which is obtained as described above may be used in its unmodified form in the drying shrinkage-reducing agent, or alternatively may be handled in the form of an aqueous solution containing no organic solvent. Specifically, the polymer may be further neutralized with an alkaline substance such as inorganic substances including hydroxide, chloride, or carbonate of a monovalent metal and a divalent metal; ammonia; and an organic amine (preferably the hydroxide of a monovalent metal like sodium hydroxide or potassium hydroxide) and used in the form of a polymer salt in the drying shrinkage-reducing agent.

The polymer according to this invention contains the structural unit (I) as an essential structural unit. The proportion of the structural unit (I) to be introduced into the polymer is particularly critical from the viewpoint of effectively repressing the drying shrinkage because the introduction of the hydrophobic group of R⁴ in the structural unit (I) serves to lower the interfacial tension between a cured cement product and water and to decrease the tensile stress of water which forms the cause for drying shrinkage. In consideration of this function, the proportion of the structural unit (I) is preferably in the range of 7-99 mass %, 7-70 mass %, 10-60 mass %, 15-60 mass %, and 15-50 mass % in this order. If the proportion of the structural unit (I) falls short of the lower limit, the shortage would possibly result in preventing the hydrophobic group from being introduced in a sufficient amount into the polymer and consequently preventing the function of lowering the tensile stress from being manifested fully satisfactorily, and impairing the polymer's effect in repressing the drying shrinkage. Conversely, if this proportion of the structural unit (I) exceeds the upper limit, the excess would possibly result in suffering the polymer to incorporate hydrophobic groups excessively therein, rendering it insoluble in water, preventing it from assuming the form of an aqueous solution and from lowering the interfacial tension between a cured cement product and water, and precluding the acquisition of fully satisfactory drying shrinkage reducing effects.

The polymer according to this invention preferably contains the structural unit (II-a) and/or the structural unit (II-b) as essential components in addition to the structural unit (I), and contains the structural unit (III) in a proportion in the range of 0-30 mass % based on the total mass of the polymer, and occasionally may contain the structural unit (IV). The proportion of the structural unit (I) in the polymer in this case is the same as the proportion mentioned above. The ratios of the other structural units (II-a), (II-b), (III), and (IV) do not need to be particularly restricted but are only required to be capable of manifesting outstanding effects for reducing and repressing the shrinkage of a cured cement product due to drying without manifesting any dispersibility. In consideration thereof, the proportion of the structural unit (II-a) is preferably in the range of 1-90 mass %, more preferably in the range of 5-80 mass %, based on the total mass of the polymer; the proportion of the structural unit (II-b) is preferably in the range of 1-90 mass %, more preferably in the range of 5-80 mass %, based on the total mass of the polymer; the proportion of the structural unit (III) is in the range of 0-30 mass % based on the total mass of the polymer; and the proportion of the structural unit (IV) is preferably in the range of 0-30 mass %, more preferably in the range of 0-20 mass %, based on the total mass of the polymer. In the proportions of the structural units cited above, it is essential that the structural unit (III) is present in a proportion in the range of 0-30 mass % based on the total mass of the polymer. In this case, if the proportion of the structural unit (III) exceeds 30 mass %, the excess would possibly result in suffering the polymer to incorporate an acid excessively and consequently compelling the polymer to be adsorbed on cement to manifest dispersibility. Further, since the hardening time of a cement product is elongated as the amount of the structural unit (III) to be introduced is increased, the structural unit (III) is preferably present in the smallest possible amount in the polymer. Thus, the proportion of the structural unit (III) is preferably in the range of 0-20 mass %, more preferably in the range of 0-15 mass %, still more preferably in the range of 0-10 mass %, and most preferably in the range of 0-5 mass %, based on the total mass of the polymer. In this case, the total of the proportions of the structural units (I), (II-a), (II-b), (III), and (IV) is 100 mass %. Further, the polymer according to this invention may be produced by directly esterifying an alkoxypolyalkylene glycol in at least part of the carboxyl group of the copolymer obtained by copolymerizing the monomer component containing the unsaturated monocarboxylic acid type monomer such as acrylic acid, methacrylic acid, or crotonic acid and the monomer (such as, for example, the monomer (a)) providing the structural unit (I).

The weight average molecular weight of the polymer according to this invention falls properly in the range of 500-500,000, preferably in the range of 500-300,000, more preferably in the range of 500-200,000, still more preferably in the range of 500-100,000, and particularly preferably in the range of 500-80,000, as expressed in terms of polystyrene determined by the gel permeation chromatography (referred to hereinafter as “GPC”). The weight average molecular weight of the polymer reported in this specification is a value determined under the following conditions for the GPC determination unless otherwise specified.

<Conditions for GPC Molecular Weight Determination>

Column used: TSK-GEL SUPER HM-H+TSK-GEL SUPER HM-H+TSK-GEL SUPER H2000, made by Toso K.K.

Eluting solution: Tetrahydrofuran (THF)

Amount supplied: 20 μl

Sample concentration: 0.2 wt %

Flow rate of eluting solution: 0.6 mL/sec

Column temperature: 40° C.

Standard substance: Polystyrene, weight average molecular weight (Mw) 587000, 354000, 189000, 98900, 37200, 17100, 9830, 5870, 2500

Detector: Differential refraction detector, made by Toso K.K.

Software for analysis: GPC8020, model II, data collection Version 4.20, made by Toso K.K.

While the drying shrinkage-reducing agent of this invention can be applied to a wide range of applications including hydraulic materials, it can be used particularly advantageously for hydraulic materials.

The drying shrinkage-reducing agent of this invention may be formed of one kind of polymer mentioned above or may be formed of two or more kinds of polymers cited above.

Further, by combining the drying shrinkage-reducing agent of this invention and a dispersing agent, the dispersibility and the drying shrinkage-reducing properties can be easily adjusted depending on the purpose. The second aspect of this invention, therefore, relates to a shrinkage-reducing composition comprising at least one kind of the drying shrinkage-reducing agent of this invention and a dispersing agent. In this invention, the drying shrinkage-reducing agents may be used either singly or in the form of a mixture of two or more members.

The dispersing agent which can be used in this invention does not need to be particularly restricted. Any of the known dispersing agents may be used. To be specific, the known dispersing agents include copolymers of alkenyl ether type monomers resulting from adding ethylene oxide to such specific unsaturated alcohol as 3-methyl-3-buten-1-ol, unsaturated carboxylic acid type monomers, and monomers copolymerizable with these monomers, or the salts thereof, as disclosed in JP-A SHO 62-68806, various sulfonic acid type dispersing agents having a sulfonic group in the molecular unit thereof, and various polycarboxylic acid type dispersing agents having a polyoxyalkylene chain and a carboxyl group in the molecular unit thereof, for example. As typical examples of the sulfonic acid type dispersing agent, lignin sulfonates; polyol derivatives; naphthalene sulfonic acid formalin condensates; melamine sulfonic acid formalin condensates; polystyrene sulfonates; and aminosulfonic acid type dispersing agents such as aminoaryl sulfonic acid-phenol formaldehyde condensates (see JP-A HEI 1-113419) may be cited.

Polycarboxylic acid type dispersing agents (A) comprising as essential structural units the structural unit (II-a) represented by the formula (2) and the structural unit (III), polycarboxylic acid type dispersing agents (B) comprising as essential structural units the structural unit (II-b) represented by the formula (3) and the structural unit (III), and hydrophilic graft polymers obtained by the graft polymerization of an unsaturated carboxylic acid monomer to a polyether compound as described in JP-A-Hei 7-53645, JP-A-Hei 8-208769 and JP-A-Hei 8-208770 may be also advantageously used as the polycarboxylic acid type dispersing agent. Among other dispersing agents cited above, the polycarboxylic acid type dispersing agents (A) and (B) may be preferably used. Thus, in preferred embodiments, the polycarboxylic acid type dispersing agent is one of the above-mentioned polycarboxylic acid type dispersing agents (A) and (B). The polycarboxylic acid type dispersing agents (A) and polycarboxylic acid type dispersing agents (B) may be used either singly or in the form of a mixture of two or more members, respectively.

The polycarboxylic acid type dispersing agent (A) is a polymer comprising, as essential structural units, the structural unit (II-a) represented by the formula (2) and the structural unit (III). It may further comprise another structural unit derived from other copolymerizable monomer (e). Each of these structural units in the polycarboxylic acid type dispersing agent (A) may comprise one single species or two or more species.

The proportion of the structural unit (II-a) and structural unit (III) (structural unit (II-a)/structural unit (III); % by mass) in the above polycarboxylic acid type dispersing agent (A) is preferably 1 to 99/99 to 1. The total content (% by mass) of the structural unit (II-a) and structural unit (III) in the polycarboxylic acid type dispersing agent (A) is preferably 50 to 100% by mass, more preferably 70 to 100% by mass, based on the total mass of the polycarboxylic acid type dispersing agent (A).

The polycarboxylic acid type dispersing agent (B) is a polymer comprising, as essential structural units, the structural unit (II-b) represented by the formula (3) and the structural unit (III). It may further comprise another structural unit derived from other copolymerizable monomer (e). These structural units in the polycarboxylic acid type dispersing agent (B) each may comprise one single species or two or more species.

In the polycarboxylic acid type dispersing agent (B), each the structural unit (II-b) and the structural unit (III) preferably accounts for at least 1% by mass of all structural units, and the proportion of the structural unit (II-b) is preferably not more than 50 mol % of all the structural units. If the proportion of the structural unit (II-b) is less than 1% by mass, the content of the oxyalkylene group(s) of the unsaturated (poly)alkylene glycol ether monomer contained in the polycarboxylic acid type dispersing agent (B) would be unduly low. On the other hand, if the proportion of the structural unit (III) is less than 1% by mass, the content of the carboxyl groups of the unsaturated monocarboxylic acid monomer contained in the polycarboxylic acid type dispersing agent (B) would be unduly low. In either case, the dispersing ability of the produced polycarboxylic acid type dispersing agent (B) would tend to decrease. Further, since the unsaturated (poly)alkylene glycol ether monomer has low polymerizability, it is preferred that the proportion of the structural unit (II-b) be not more than 50 mol % of all the structural units so that the polycarboxylic acid type dispersing agent (B) can be obtained with excellent dispersibility in a high yield. The total proportion (% by mass) of the structural units (II-b) and (III) in the polycarboxylic acid type dispersing agent (B) may be preferably 50 to 100% by mass, more preferably 70 to 100% by mass, based on the total mss of the polycarboxylic acid type dispersing agent (B).

Alternatively, a commercially available cement dispersing agent can be used. As typical examples of the commercial product, Pozzolith No. 70 (lignin sulfonic acid compound polyol complex type dispersing agent, made by Pozzolith Bussan K.K.), and FC-900 (polycarboxylic acid type dispersing agent, made by Nippon Shokubai Co. Ltd.) may be cited. The known cement dispersing agents mentioned above may be used either singly or in the form of a mixture of two or more members.

In this invention, the mass ratios of the drying shrinkage-reducing agent and the dispersing agent to be formulated do not need to be particularly restricted but may be varied with the kinds of drying shrinkage-reducing agent and cement dispersing agent, the mixing ratio thereof, and the conditions of testing. The ratio falls preferably in the range of 99.5:0.5-0.5:99.5, more preferably in the range of 99:1-10:90, and particularly preferably in the range of 98:2-20:80. In this case, if the ratio of the drying shrinkage-reducing agent exceeds 99.5 mass % of the whole composition, the excess would be at a disadvantage in decreasing the ratio of the dispersing agent, unduly lowering the fluidity, and inducing inferior packing. Conversely, if the ratio of the drying shrinkage-reducing agent falls short of 0.5 mass % of the whole composition, the shortage would possibly result in excessively decreasing the amount of the drying shrinkage-reducing agent, and failing to decrease the drying shrinkage of the concrete member satisfactorily.

The drying shrinkage-reducing agent of this invention may be used in the form of an aqueous solution, or in the form of a powder prepared by neutralizing it with the hydroxide of a divalent metal such as calcium or magnesium to give a polyvalent metal salt thereof and drying the salt, or by depositing the polymer or salt on an inorganic powder such as a fine silica based powder and drying the deposited product.

The drying shrinkage-reducing agent of this invention can be used in various hydraulic materials, namely in cement and other hydraulic materials then cement, for example gypsum. Preferred examples of the hydraulic composition comprising a hydraulic material, water and the drying shrinkage-reducing agent of this invention, and optionally a fine aggregate (e.g. sand) or a coarse aggregate (e.g. crushed stone) may be cement paste, mortar, concrete and plaster.

Among the hydraulic compositions cited above, shrinkage-reducing compositions in which cement is used as the hydraulic material are in commonest use. Such a shrinkage-reducing composition comprises the drying shrinkage-reducing agent of this invention, cement and water as essential constituents. Such a shrinkage-reducing composition is also involved in the scope of this invention.

As the cement which can be used in the shrinkage-reducing composition of this invention, portland cements (ordinary, high-early-strength, ultra high-early-strength, moderate heat, sulfate resistant, and low alkali grades thereof), various blended cements (blast furnace slag cement, silica cement, fly ash cement), white portland cement, calcium-aluminate cement, ultra rapid hardening cement (one clinker ultra rapid hardening cement, two clinker ultra rapid hardening cement, magnesium phosphate cement), grouting cement, oil-well cement, lower calorific value cement (lower calorific value blast furnace slag cement, fly ash-mixed lower calorific value blast furnace slag cement, high belite cement), ultrahigh strength cement, cement-based hardening materials, and economical cement (cement produced by using at least one of municipal refuse incineproportionn ash and sewage sludge incineproportionn ash as a material) can be advantageously used. Fine powders such as blast furnace slag, fly ash, cinder ash, clinker ash, husk ash, silica fume, silica powder and limestone powder, and gypsum may further be added. As the aggregate, gravel, crushed stone, water granulated blast furnace slag, recycled concrete aggregate and, further, fireproof aggregates such as silica stone-based, clay-based, zircon-based, high alumina, silicon carbide-based, graphite-based, chrome-based, chrome-magnesite, and magnesia-based ones can be used.

As for the unit water amount, the amount of cement used and the water/cement ratio, in each cubic meter of the shrinkage-reducing composition of this invention, the unit water amount is preferably set to a level in the range of 100 to 185 kg/m³; the amount of cement used is preferably set to a level in the range of 250 to 800 kg/m³, and the water/cement ratio (mass ratio) is preferably set to a level in the range of 0.1 to 0.7. More preferably, the unit water amount is in the range of 120 to 175 kg/m³, the amount of cement used is in the range of 270 to 800 kg/m³, and the water/cement ratio (mass ratio) is in the range of 0.2 to 0.65. In the ranges as mentioned above, the shrinkage-reducing composition of this invention can be used in such a wide range as from poor to rich mixtures, and also can be applied both to high strength concrete with a high unit cement amount and to poor concrete with a unit cement amount of not more than 300 kg/m³.

The amount of the drying shrinkage-reducing agent of this invention formulated in the shrinkage-reducing composition of this invention is preferably in the range of 0.001 to 20.0% by mass based on the mass of cement when it is used in mortar or concrete, for instance, in which hydraulic cement is used. If the amount is lower than 0.001% by mass, the obtained shrinkage-reducing composition would manifest unduly low shrinkage reducing ability. Conversely, when it exceeds 20.0% by mass, the curing time of hydraulic materials would be easily extended. The amount of the drying shrinkage-reducing agent to be formulated is more preferably in the range of 0.001 to 10.0% by mass, still more preferably 0.05 to 5.0% by mass, most preferably 0.01 to 3.0% by mass.

The shrinkage-reducing composition of this invention is effective in ready mixed concrete, concrete for secondary concrete products (precast concrete), centrifugal molded concrete, vibrating compacted concrete, steam cured concrete, concrete for spraying and the like and, further, it is effective also in mortar and concrete species required to have high flowability, such as medium flowing concrete (concrete showing a slump value of 22 to 25 cm), high flowing concrete (concrete showing a slump value of not less than 25 cm and a slump flow value of 50 to 70 cm), self-filling concrete and self-leveling materials.

The shrinkage-reducing composition of this invention may further comprise one or more of other known cement additives (ingredients) such as listed below under (1) to (20):

(1) Water-soluble polymeric substances: unsaturated carboxylic acid polymers such as polyacrylic acid (sodium salt), polymethacrylic acid (sodium salt), polymaleic acid (sodium salt), and acrylic acid-maleic acid copolymer sodium salt; nonionic cellulose ethers such as methylcellulose, ethylcellulose, hydroxymethylcellulose, hydroxyethylcellulose, carboxymethylcellulose, carboxyethylcellulose and hydroxypropylcellulose; polysaccharide derivatives having a part or all hydrogen atoms of hydroxyl group(s) in an alkylated or hydroxyalkylated derivative of polysaccharide, such as methylcellulose, ethylcellulose, hydroxyethylcellulose and hydroxypropylcellulose substituted with a hydrophobic substituent comprising a hydrocarbon chain of 8 to 40 carbon atoms as a partial structure and an ionic hydrophilic substituent containing a sulfonic acid group or the salt thereof as a partial structure; polysaccharides produced by microbial fermentation such as yeast glucans, xanthan gum, β-1,3-glucans (linear or branched, e.g. curdlan, paramylon, pachyman, scleroglucan, rhamnalan) and the like; polyacrylamide; polyvinyl alcohol; starch; starch phosphoric acid ester; sodium alginate; gelatin; amino-containing acrylic acid copolymers and quaternary products thereof.

(2) Polymer emulsions: copolymers of various vinyl monomer such as alkyl (meth)acrylates.

(3) Retardants: oxycarboxylic acids such as gluconic acid, glucoheptonic acid, arabonic acid, malic acid, citric acid, and inorganic or organic salts thereof such as sodium, potassium, calcium, magnesium, ammonium and triethanolamine salts; monosaccharides such as glucose, fructose, galactose, saccharose, xylose, apiose, ribose and invert sugar, oligosaccharides such as disaccharides and trisaccharides, such oligosaccharides as dextrin, polysaccharides such as dextran, and other saccharides such as molasses containing these saccharides; sugar alcohols such as sorbitol; magnesium silicofluoride; phosphoric acid and salts thereof, or borate esters; aminocarboxylic acids and salts thereof; alkali-soluble proteins; humic acid; tannic acid; phenols; polyhydric alcohols such as glycerol; phosphonic acids and derivatives thereof, such as aminotri(methylenephosphonic acid), 1-hydroxyethylidene-1,1-diphosphonic acid, ethylenediaminetetra(methylenephosphonic acid), diethylenetriaminepenta(methylenephosphonic acid), and alkali metal or alkaline earth metal salts thereof, etc.

(4) Early strengthening agents/accelerators: soluble calcium salts such as calcium chloride, calcium nitrite, calcium nitrate, calcium bromide and calcium iodide; chlorides such as iron chloride and magnesium chloride; sulfate salts; potassium hydroxide; sodium hydroxide; carbonate salts; thiosulfate salts; formic acid and formate salts such as calcium formate; alkanolamines; calcium-aluminate cement; calcium aluminosilicate, etc.

(5) Mineral oil-based antifoaming agents: kerosene, liquid paraffin, etc.

(6) Fat- or oil-based antifoaming agents: animal or vegetable oils, sesame oil, castor oil, and the alkylene oxide adducts thereof, etc.

(7) Fatty acid-based antifoaming agents: oleic acid, stearic acid, and the alkylene oxide adducts thereof, etc.

(8) Fatty acid ester-based antifoaming agents: glycerol monoricinolate, alkenylsuccinic acid derivatives, sorbitol monolaurate, sorbitol trioleate, natural waxes, etc.

(9) Oxyalkylene type antifoaming agents: polyoxyalkylenes such as (poly)oxyethylene(poly)oxypropylene adducts; (poly) oxyalkyl ethers such as diethylene glycol heptyl ether, polyoxyethylene oleyl ether, polyoxypropylene butyl ether, polyoxyethylenepolyoxypropylene 2-ethylhexyl ether, and higher (C₁₂-C₁₄) alcohol-oxyethyleneoxypropylene adducts; (poly)oxyalkylene (alkyl)aryl ethers such as polyoxypropylene phenyl ether and polyoxyethylene nonylphenyl ether; acetylene ethers produced by addition polymerization of an alkylene oxide onto an acetylene alcohol such as 2,4,7,9-tetramethyl-5-decyne-4,7-diol, 2,5-dimethyl-3-hexyne-2,5-diol or 3-methyl-1-butyn-3-ol; (poly)oxyalkylene fatty acid esters such as diethylene glycol oleate, diethylene glycol laurate and ethylene glycol distearate; (poly)oxyalkylene sorbitan fatty acid esters such as polyoxyethylenesorbitan monolaurate and polyoxyethylenesorbitan trioleate; (poly)oxyalkylene alkyl(aryl)ether sulfate ester salts such as polyoxypropylene methyl ether sulfate sodium salt and polyoxyethylene dodecylphenyl ether sulfate sodium salt; (poly)oxyalkylene alkylphosphate esters such as polyoxyethylene stearylphosphate; (poly)oxyalkylenealkylamines such as polyoxyethylenelaurylamine; polyoxyalkyleneamides, etc.

(10) Alcohol-based antifoaming agents: octyl alcohol, hexadecyl alcohol, 2-Ethylhexyl alcohol, acetylene alcohols, glycols, etc.

(11) Amide-based antifoaming agents: acrylate polyamines, etc.

(12) Phosphate ester-based antifoaming agents: tributyl phosphate, sodium octylphosphate, etc.

(13) Metal salt-based antifoaming agents: aluminum stearate, calcium oleate, etc.

(14) Silicone-based antifoaming agents: dimethylsilicone oil, silicone paste, silicone emulsions, organic group-modified polysiloxanes (organosiloxanes such as dimethylpolysiloxane), fluorosilicone oils, etc.

(15) Air-entraining (AE) agents: resin soaps, saturated or unsaturated fatty acids, sodium hydroxystearate, lauryl sulfate, ABSs (alkylbenzenesulfonates), LASs (linear alkylbenzenesulfonates), alkanesulfonates, polyoxyethylene alkyl(phenyl)ethers, polyoxyethylene alkyl(phenyl)ether sulfate esters or salts thereof, polyoxyethylene alkyl(phenyl)ether phosphate esters or salts thereof, proteinic materials, alkenylsulfosuccinates, α-olefinsulfonates, etc.

(16) Other surfactants: polyalkylene oxide derivatives derived from aliphatic monohydric alcohols of 6 to 30 carbon atoms within the molecule, such as octadecyl alcohol and stearyl alcohol, alicyclic monohydric alcohols of 6 to 30 carbon atoms within the molecule, such as abietyl alcohol, monofunctional mercaptans of 6 to 30 carbon atoms within the molecule, such as dodecylmercaptan, alkylphenols of 6 to 30 carbon atoms within the molecule, such as nonylphenol, amines of 6 to 30 carbon atoms within the molecule, such as dodecylamine, or carboxylic acids of 6 to 30 carbon atoms within the molecule, such as lauric acid and stearic acid, by addition of not less than 10 moles of an alkylene oxide (s) such as ethylene oxide and/or propylene oxide; alkyldiphenyl ether sulfonic acid salts in which two sulfo-containing phenyl groups, which may optionally have an alkyl group or alkoxy group as a substituent, is bonded via ether bonding; various anionic surfactants; various cationic surfactants such as alkylamine acetates and alkyltrimethylammonium chlorides; various nonionic surfactants; various amphoteric surfactants, etc.

(17) Waterproofing agents: fatty acids (salts), fatty acid esters, fats and oils, silicones, paraffins, asphalt, waxes, etc.

(18) Rust preventives: nitrite salts, phosphate salts, zinc oxide, etc.

(19) Cracking reducing agents: polyoxyalkyl ethers etc.

(20) Expansive admixtures: ettringite type, coal-derived type, etc.

As other conventional cement additives (ingredients), cement wetting agents, thickening agents, sepaproportionn reducing agents, flocculants, strength increasing agents, self-leveling agents, colorants, antifungal agents and the like can be used. These cement additives (ingredients) can be used in combination.

The following combinations 1) to 8) of constituents other than cement and water in the shrinkage-reducing composition of this invention may be mentioned as particularly preferred embodiments:

1) Combination of (a) a drying shrinkage-reducing agent of this invention and (b) an oxyalkylene type antifoaming agent as two essential constituents. The proportion of the (b) oxyalkylene type antifoaming agent is preferably in the range of 0.01 to 200% by mass relative to the (a) drying shrinkage-reducing agent.

2) Combination of (a) a drying shrinkage-reducing agent of this invention and (b) a ligninsulfonic acid (salts) as two essential constituents. The mixing proportion, by mass, between the (a) drying shrinkage-reducing agent and the (b) ligninsulfonic acid (salts) is preferably in the range of 99.5/0.5 to 0.5/99.5, more preferably 98/2 to 20/80.

3) Combination of (a) a drying shrinkage-reducing agent of this invention and (b) a polycarboxylic acid type dispersing agent as two essential constituents. The mixing proportion, by mass, between the (a) drying shrinkage-reducing agent and the (b) polycarboxylic acid type dispersing agent is preferably in the range of 99.5/0.5 to 0.5/99.5, more preferably 98/2 to 20/80.

4) Combination of (a) a drying shrinkage-reducing agent of this invention, (b) a ligninsulfonic acid (salts) and (c) an oxyalkylene type antifoaming agent as three essential constituents. The mixing proportion, by mass, between the (a) drying shrinkage-reducing agent and the (b) ligninsulfonic acid (salts) is preferably in the range of 99.5/0.5 to 0.5/99.5, more preferably 98/2 to 20/80. And the proportion of the (c) oxyalkylene type antifoaming agent is preferably in the range of 0.01 to 200% by mass relative to the total mass of the (a) drying shrinkage-reducing agent and the (b) ligninsulfonic acid (salts).

5) Combination of (a) a drying shrinkage-reducing agent of this invention, (b) a polycarboxylic acid type dispersing agent and (3) an oxyalkylene type antifoaming agent as three essential constituents. The mixing proportion, by mass, between the (a) drying shrinkage-reducing agent and the (b) polycarboxylic acid type dispersing agent is preferably in the range of 99.5/0.5 to 0.5/99.5, more preferably 98/2 to 20/80. And the proportion of the (c) oxyalkylene type antifoaming agent is preferably in the range of 0.01 to 200% by mass relative to the total mass of the (a) drying shrinkage-reducing agent and thw (b) polycarboxylic acid type dispersing agent.

6) Combination of (a) a drying shrinkage-reducing agent of this invention and (b) a material sepaproportionn reducing agent as two essential constituents. Usable as the material sepaproportionn reducing agent are various thickening agents such as nonionic cellulose ethers, and compounds containing, as partial structures, a hydrophobic substituent comprising a hydrocarbon chain of 4 to 30 carbon atoms and a polyoxyalkylene chain resulting from addition of 2 to 300 moles, on average, of an alkylene oxide(s) of 2 to 18 carbon atoms, among others. The mixing proportion, by mass, between the (a) drying shrinkage-reducing agent and the (b) material sepaproportionn reducing agent is preferably in the range of 10/90 to 99.99/0.01, more preferably 50/50 to 99.9/0.1. Shrinkage-reducing compositions containing this combination are suited for the use as high flowing concrete, self-filling concrete and self-leveling composition.

7) Combination of (a) a drying shrinkage-reducing agent of this invention and (b) a retardant as two essential constituents. Usable as the retardant are hydroxycarboxylic acids such as gluconic acid (salts) and citric acid (salts), saccharides such as glucose, sugar alcohols such as sorbitol, and phosphonic acids such as aminotri(methylenephosphonic acid), among others. Among them, hydroxycarboxylic acids such as gluconic acid (salts) and citric acid (salts) are more preferably used. The mixing proportion, by mass, between the (a) drying shrinkage-reducing agent and the (b) retardant is preferably 50/50 to 99.9/0.1, more preferably 70/30 to 99/1.

8) Combination of (a) a drying shrinkage-reducing agent of this invention and (b) an accelerator as two essential constituents. Usable as the accelerator are soluble calcium salts such as calcium chloride, calcium nitrite and calcium nitrate, chlorides such as iron chloride and magnesium chloride, thiosulfate salts, formic acid, and formate salts such as calcium formate, among others. The mixing proportion, by mass, between the (a) drying shrinkage-reducing agent and the (b) accelerator is preferably 10/90 to 99.9/0.1, more preferably 20/80 to 99/1.

### EXAMPLES

Now, this invention will be described more specifically below with reference to working examples. In the present specification, “%” will be referred to as “mass %” and “parts” to as “mass parts”, unless otherwise specified.

### Production Example 1

In a glass reaction vessel equipped with a thermometer, a stirrer, a dropping funnel, a nitrogen conducting tube, and a reflux condenser, 198.91 parts of 2-propanol, 54.51 parts of 2-ethylhexyl methacrylate, 67.99 parts of methoxypolyethylene glycol monomethacrylate (average addition mol number of ethylene oxide of 23; namely in the above formula (2), R⁵=H, R⁶=H, R⁷=CH₃, R⁸=C₂H₄, R⁹=CH₃, s=0, and u=23), and 0.71 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol and then diluted with water so as to give the copolymer concentration 25 mass %, to obtain a polymer (1) of this invention formed of an aqueous copolymer solution having a weight average molecular weight of 13,300. The weight average molecular weight was determined under the same conditions as the GPC as mentioned above.

### Production Example 2

In a glass reaction vessel equipped with a thermometer, a stirrer, a dropping funnel, a nitrogen conducting tube, and a reflux condenser, 198.91 parts of 2-propanol, 46.92 parts of 2-ethylhexyl methacrylate, 75.58 parts of methoxypolyethylene glycol monomethacrylate (average addition mol number of ethylene oxide of 9; namely in the above formula (2), R⁵=H, R⁶=H, R⁷=CH₃, R⁸=C₂H₄, R⁹=CH₃, s=0, and u=9), and 0.62 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol and then diluted with water so as to give the copolymer concentration 25 mass %, to obtain a polymer (2) of this invention formed of an aqueous copolymer solution having a weight average molecular weight of 13,300. The weight average molecular weight was determined under the same conditions as the GPC as mentioned above.

### Production Example 3

In a glass reaction vessel equipped with a thermometer, a stirrer, a dropping funnel, a nitrogen conducting tube, and a reflux condenser, 198.91 parts of 2-propanol, 55.17 parts of 2-ethylhexyl methacrylate, 62.53 parts of methoxypolyethylene glycol monomethacrylate (average addition mol number of ethylene oxide of 23; namely in the above formula (2), R⁵=H, R⁶=H, R⁷=CH₃, R⁸=C₂H₄, R⁹=CH₃, s=0, and u=23), 4.80 parts of methacrylic acid, and 0.83 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol and then diluted with water so as to the copolymer concentration 25 mass %, and then neutralized with an aqueous 30% sodium hydroxide solution, to obtain a polymer (3) of this invention formed of an aqueous copolymer solution having a weight average molecular weight of 12,000. The weight average molecular weight was determined under the same conditions as the GPC as mentioned above.

### Production Example 4

In a glass reaction vessel equipped with a thermometer, a stirrer, a dropping funnel, a nitrogen conducting tube, and a reflux condenser, 198.91 parts of 2-propanol, 47.30 parts of 2-ethylhexyl methacrylate, 71.09 parts of methoxypolyethylene glycol monomethacrylate (average addition mol number of ethylene oxide of 9; namely in the above formula (2), R⁵=H, R⁶=H, R⁷=CH₃, R⁸=C₂H₄, R⁹=CH₃, s=0, and u=9), 4.11 parts of methacrylic acid, and 0.91 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain a polymer (4) of this invention formed of an aqueous copolymer solution having a weight average molecular weight of 13,000. The weight average molecular weight was determined under the same conditions as the GPC as mentioned above.

### Production Example 5

In a glass reaction vessel equipped with a thermometer, a stirrer, a dropping funnel, a nitrogen conducting tube, and a reflux condenser, 199.34 parts of 2-propanol, 46.92 parts of 2-ethylhexyl acrylate, 75.58 parts of IPN10 (in the above formula (3), R¹⁰=H, R¹¹=H, R¹²=CH₃, R¹³=C₂H₄, R¹⁴=H, x=2, and y=10), and 0.63 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.84 parts of 2,2′-azobis(2,4-dimethyl valeronitrile) and 28.2 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, and then diluted with water so as to give the copolymer concentration 25 mass %, to obtain a polymer (5) of this invention formed of an aqueous copolymer solution having a weight average molecular weight of 6,100. The weight average molecular weight was determined under the same conditions as the GPC as mentioned above.

### Production Example 6

In a glass reaction vessel equipped with a thermometer, a stirrer, a dropping funnel, a nitrogen conducting tube, and a reflux condenser, 198.91 parts of 2-propanol, 47.30 parts of butyl methacrylate, 71.09 parts of methoxypolyethylene glycol monomethacrylate (average addition mol number of ethylene oxide of 9; namely in the above formula (2), R⁵=H, R⁶=H, R⁷=CH₃, R⁸=C₂H₄, R⁹=CH₃, s=0, and u=9), 4.11 parts of methacrylic acid, and 0.72 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain the polymer (6) of this invention formed of an aqueous copolymer solution having a weight average molecular weight of 15,200. The weight average molecular weight was determined under the same conditions as the GPC as mentioned above.

### Production Example 7

In a glass reaction vessel equipped with a thermometer, a stirrer, a dropping funnel, a nitrogen conducting tube, and a reflux condenser, 198.91 parts of 2-propanol, 47.30 parts of lauryl methacrylate, 71.09 parts of methoxypolyethylene glycol monomethacrylate (average addition mol number of ethylene oxide of 9, namely in the above formula (2), R⁵=H, R⁶=H, R⁷=CH₃, R⁸=C₂H₄, R⁹=CH₃, s=0, and u=9), 4.11 parts of methacrylic acid, and 1.12 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain a polymer (7) of this invention formed of an aqueous copolymer solution having a weight average molecular weight of 12,600. The weight average molecular weight was determined under the same conditions as the GPC as mentioned above.

### Production Example 8

In a glass reaction vessel equipped with a thermometer, a stirrer, a dropping funnel, a nitrogen conducting tube, and a reflux condenser, 198.91 parts of 2-propanol, 30.89 parts of 2-ethylhexyl methacrylate, 87.50 parts of methoxypolyethylene glycol monomethacrylate (average addition mol number of ethylene oxide of 9; namely in the above formula (2), R⁵=H, R⁶=H, R⁷=CH₃, R⁸=C₂H₄, R⁹=CH₃, s=0, and u=9), 4.11 parts of methacrylic acid, and 0.81 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain a polymer (8) of this invention formed of an aqueous copolymer solution having a weight average molecular weight of 13,400. The weight average molecular weight was determined under the same conditions as the GPC as mentioned above.

### Production Example 9

In a glass reaction vessel equipped with a thermometer, a stirrer, a dropping funnel, a nitrogen conducting tube, and a reflux condenser, 198.91 parts of 2-propanol, 12.36 parts of 2-ethylhexyl methacrylate, 106.03 parts of methoxypolyethylene glycol monomethacrylate (average addition mol number of ethylene oxide of 9; namely in the above formula (2), R⁵=H, R⁶=H, R⁷=CH₃, R⁸=C₂H₄, R⁹=CH₃, s=0, and u=9), 4.11 parts of methacrylic acid, and 0.86 part of 3-mercaptopropionic acid as a chain transfer agent were placed and stirred while the interior of the reaction vessel was displaced with nitrogen and heated under an atmosphere of nitrogen to 65° C. Next, an initiator solution composed of 1.41 parts of 2,2′-azobis(2,4-dimethyl valeronitrile) and 28.6 parts of 2-propanol was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain a polymer (9) of this invention formed of an aqueous copolymer solution having a weight average molecular weight of 12,000. The weight average molecular weight was determined under the same conditions as the GPC as mentioned above.

### Comparative Production Example 1

In a glass reaction vessel equipped with a thermometer, a stirrer, a dropping funnel, a nitrogen conducting tube, and a reflux condenser, 181.3 parts of 2-propanol, 6.1 parts of deionized water, 22.7 parts of methoxypolyethylene glycol monomethacrylate (average addition mol number of ethylene oxide of 23), 22.7 parts of lauryl methacrylate, 36.2 parts of methacrylic acid, and 0.28 part of 3-mercaptopropionic acid as a chain transfer agent were placed and stirred while the interior of the reaction vessel was displaced with nitrogen and heated under an atmosphere of nitrogen to 65° C. Next, an initiator solution composed of 2.1 parts of sodium persulfate and 27.9 parts of deionized water was added dropwise thereto over a period of five hours. Thereafter, the interior temperature of the reaction vessel was continuously maintained at 65° C. for one hour to complete the polymerization. The resultant reaction solution was distilled to expel the 2-propanol, diluted with water so as to give the copolymer concentration 25 mass %, and then neutralized with an aqueous 30% sodium hydroxide solution, to obtain a comparative polymer (1) of this invention formed of an aqueous copolymer solution having a weight average molecular weight of 32,000. The weight average molecular weight of the comparative polymer (1) was determined by the following method.

<Conditions for Determination of GPC Molecular Weight>

Column used: TSK guard column SWXL+TSK gel G4000SWXL+G3000SWXL+G2000SWXLL, made by Toso K.K.

Eluting solution: Prepared by dissolving 115.6 g of sodium acetate trihydrate in a mixed solvent composed of 10999 g of water and 6001 g of acetonitrile and adjusting the resultant solution with an aqueous 30% sodium hydroxide solution to pH 6.0.

Amount supplied: 100 μL

Eluting solution: The eluting solution was prepared by dissolving 115.6 g of sodium acetate trihydrate in a mixed solvent of 10,999 g of water and 6,001 g of acetinitrile, adjusting the pH of the resultant solution to 6.0 with an aqueous 30% sodium hydroxide solution.

Amount supplied: 100 μl

Sample concentration: 0.5 wt %

Flow rate of eluting solution: 0.8 mL/sec

Column temperature: 35° C.

Standard substance: Polyethylene glycol, weight average molecular weight (Mw) 272500, 219300, 85000, 46000, 24000, 12600, 4250, 7100, 1470

Detector: Differential refraction detector, made by Nippon Waters K.K.

Software for analysis: Millennium Ver. 2.18, made by Nippon Waters K.K.

### Comparative Production Example 2

In a glass reaction vessel equipped with a thermometer, a stirrer, a dropping funnel, a nitrogen conducting tube, and a reflux condenser, 210.0 parts of methanol and 164.4 parts of deionized water were placed and stirred while the interior of the reaction vessel was displaced with nitrogen and heated under an atmosphere of nitrogen to 65° C. Next, an aqueous monomer solution prepared by mixing 150.0 parts of lauryl alkoxy polyethylene glycol monomethacrylate (average addition mol number of ethylene oxide of 25; namely in the above formula (2), R⁵=H, R⁶=H, R⁷=CH₃, R⁸=C₂H₄, R⁹=C₁₂H₂₅, s=0, and u=25), 60.0 parts of methoxypolyethylene glycol monomethacrylate (average addition mol number of ethylene oxide of 23), 71.7 parts of methacrylic acid, 60.4 parts of deionized water, and 0.74 part of 3-mercaptopropionic acid as a chain transfer agent was added dropwise thereto over a period of four hours, and simultaneously with the initiation of the dropwise addition of the aqueous monomer solution, an aqueous initiator solution composed of 6.9 parts of sodium persulfate and 93.1 parts of deionized water was added dropwise thereto over five hours. Thereafter, the interior temperature of the reaction vessel was continuously maintained at 65° C. for one hour to complete the polymerization. The resultant reaction solution was neutralized with an aqueous 30% sodium hydroxide solution and then distilled to expel the methanol, to obtain a comparative polymer (2) formed of an aqueous copolymer solution having a weight average molecular weight of 53,600. The weight average molecular weight of the comparative polymer (2) was determined in the same manner as in Comparative Production Example 1.

### Comparative Production Example 3

In a glass reaction vessel equipped with a thermometer, a stirrer, a dropping funnel, a nitrogen conducting tube, and a reflux condenser, 63.0 parts of 2-propanol and 99.4 parts of deionized water were placed and stirred while the interior of the reaction vessel was displaced with nitrogen and heated under an atmosphere of nitrogen to 65° C. Next, an aqueous monomer solution formed by mixing 29.3 parts of stearyl alkoxy polyethylene glycol monomethacrylate (average addition mol number of ethylene oxide of 25; namely in the above formula (2), R⁵=H, R⁶=H, R⁷=CH₃, R⁸=C₂H₄, R⁹=C₁₈H₃₇, s=0, and u=25), 29.3 parts of 1-pentyloxypolyethylene glycol monomethacrylate (average addition mol number of ethylene oxide of 25; namely in the above formula (2), R⁵=H, R⁶=H, R⁷=CH₃, R⁸=C₂H₄, R⁹=C₅H₁₁, s=0, and u=25), 13.5 parts of methoxypolyethylene glycol monomethacrylate (average addition mol number of ethylene oxide of 23), 14.3 parts of methacrylic acid, 20.9 parts of deionized water and 0.12 part of 3-mercaptopropionic acid as a chain transfer agent was added dropwise thereto over a period of four hours, and simultaneously with the initiation of the dropwise addition of the aqueous monomer solution, an aqueous initiator solution composed of 2.1 parts of sodium persulfate and 27.9 parts of deionized water was added dropwise thereto over five hours. Thereafter, the interior temperature of the reaction vessel was continuously maintained at 65° C. for one hour to complete the polymerization. The resultant reaction solution was distilled to expel the 2-propanol, to obtain a comparative polymer (3) formed of an aqueous copolymer solution having a weight average molecular weight of 60,600. The weight average molecular weight of the comparative polymer (3) was determined in the same manner as in Comparative Production Example 1.

### Examples 1-9 and Comparative Examples 1-3

Polymers (1)-(9) produced by following the procedures of Production Examples 1-9 and comparative polymers (1)-(3) produced by following the procedures of Comparative Production Examples 1-3 were examined for surface tension in a solution containing 0.2 mass % of a polymer in a cement supernatant, amount of standard addition, and drying shrinkage-reducing effect. The results are shown in Table 1 below. The amount of standard addition and the drying shrinkage-reducing effect were examined as shown below and the surface tension in the solution containing 0.2 mass % of a polymer in a cement supernatant was determined by the method described above.

1. Determination of Amount of Standard Addition

The kneading of mortar was carried out as follows. In a Hobart type mortar mixer, Model No. N-50 (made by Hobart K.K.), 213.7 g of a dilution prepared by weighing a prescribed amount of a polymer/comparative polymer and diluting it with water, 485.8 g of ordinary portland cement made by Taiheiyo Cement K.K., and 1350 g of a standard sand for testing cement strength (specified in 5.1.3., Annex 2 to JIS {Japanese Industrial Standard} R 5201-1997) were mixed and kneaded into a mortar in accordance with JIS R 5201-1997. Then, the amount of addition necessary to accomplish 180±10 mm/15 strokes in a mortar flow test was determined. In this case, the air content of a given mortar was adjusted, when necessary, by selecting and using a defoaming agent so as to have the amount of air entrained by the mortar fall in the range of 5.0-10.0 vol %. In Table 1, “wt % C” indicates an amount of a polymer added to the cement.

2. Drying Shrinkage-Reducing Effect

The kneading of mortar was carried out as follows. In a Hobart type mortar mixer, Model No. N-50 (made by Hobart K.K.), 213.7 g of a dilution prepared by weighing a polymer/comparative polymer in the standard amount of addition found in 1. above (regarding the polymers (1)-(9), the amount of addition was fixed at 1.5 wt %/C because the value of mortar flow was not increased by increasing the amount of addition) and diluting it with water, 485.8 g of ordinary portland cement made by Taiheiyo Cement K.K., and 1350 g of a standard sand for testing cement strength (specified in 5.1.3., Annex 2 to JIS {Japanese Industrial Standard} R 5201-1997) were mixed and kneaded into a mortar in accordance with JIS R 5201-1997. In this case, the air content of a given mortar was adjusted, when necessary, by selecting and using a defoaming agent so as to have the amount of air entrained by the mortar fall in the range of 5.0-10.0 vol %. For control, a dilution prepared by adding Pozzolith No. 70 (ligninsulfonic acid compound polyol complex type dispersing agent, produced by Pozzolith Bussan K.K.) in a concentration of 0.25 wt %/C was used in place of the polymer.

Next, a mortar test specimen (4×4×16 cm) for the examination of the drying shrinkage-reducing effect was prepared in accordance with JIS R 1129.

The retaining mold was coated in advance with silicone grease in order to obtain waterproofness and facilitate release therefrom. The test specimen had gauge plugs attached one each to the opposite ends thereof. The mortar resulting from the kneading was pored into the retaining mold. Then, the mold was placed in a container, sealed tightly therein and retained at 20° C. to effect initial curing. Two days thereafter, the cured mortar was extracted from the retaining mold, the silicone grease adhering to the mold was removed by washing with a scrubbing brush and water, and subsequently the mortar was left aging in still water at 20° C. for five days (curing in water).

A dial gauge (made by Nishinippon Shikenki K.K.) was used in accordance with JIS A 1129. The test specimen cured in the still water for five days was wiped with paper towel to remove the water remaining on the surface thereof and immediately measured to determine the length thereof. The length found at this point was taken as a standard. Thereafter, the test specimen was stored in a thermo-hygrostat set at a temperature of 20° C. and 60% of humidity for 28 days, during which period the length of the test specimen was measured at proper intervals. In this case, the drying shrinkage-reducing effect was reported as a value of the decrease in the shrinkage at the time of addition of the polymer relative to the amount of shrinkage of the Pozzolith. This value increased in accordance as the decrease in the shrinkage grew. The value of not more than 10% was regarded that the shrinkage-reducing effect was absent.
Drying shrinkage-reducing effect (%)={[(Amount of shrinkage of Pozzolith)−(Amount of shrinkage of polymer/comparative polymer)]/(Amount of shrinkage of Pozzolith)}×100 [Formula 1]

TABLE 1

| | | | Pol- | Pol- | Pol- | Pol- | Pol- | Pol- | Pol- | Pol- | Pol- | | | |
|---|---|---|---|---|---|---|---|---|---|---|---|---|---|---|
| | | | ymer | ymer | ymer | ymer | ymer | ymer | ymer | ymer | ymer | Comp. | Comp. | Comp. |
| | | | 1 | 2 | 3 | 4 | 5 | 6 | 7 | 8 | 9 | Polymer 1 | Polymer 2 | Polymer 3 |
| Compo- | Structural | 2-Ethylhexyl | 44.5 | 38.3 | 44.6 | 38.3 | | | | 25.0 | 10.0 | | | |
| sition | unit I | methacrylate | | | | | | | | | | | | |
| (wt %) | | 2-Ethylhexyl | | | | | 38.3 | | | | | | | |
| | | acrylate | | | | | | | | | | | | |
| | | Butyl | | | | | | 38.3 | | | | | | |
| | | methacrylate | | | | | | | | | | | | |
| | | Lauryl | | | | | | | 38.3 | | | 27.8 | | |
| | | methacrylate | | | | | | | | | | | | |
| | Structural | PGM23E ※1 | 55.5 | | 50.5 | | | | | | | 27.8 | 20.0 | 15.6 |
| | unit II | PGM9E ※2 | | 61.7 | | 57.5 | | 57.5 | 57.5 | 70.8 | 85.8 | | | |
| | | PGLa25E ※3 | | | | | | | | | | | 49.9 | |
| | | PGSt25E ※4 | | | | | | | | | | | | 33.9 |
| | | PGPt25E ※5 | | | | | | | | | | | | 33.9 |
| | | IPN10 ※6 | | | | | 61.7 | | | | | | | |
| | Structural | Sodium | | | 4.9 | 4.2 | | 4.2 | 4.2 | 4.2 | 4.2 | 44.4 | 30.1 | |
| | unit III | methacrylate | | | | | | | | | | | | |
| | | Methacrylic | | | | | | | | | | | | 16.6 |
| | | acid | | | | | | | | | | | | |

| | | | | | | | | | | | | |
|---|---|---|---|---|---|---|---|---|---|---|---|---|
| Surface tension (mN/m) | 46.3 | 39.8 | 40.9 | 37.7 | 42.0 | 39.7 | 41.3 | 41.6 | 40.9 | 65.1 | 54.5 | 60.6 |
| Amount of standard addition | 1.5< | 1.5< | 1.5< | 1.5< | 1.5< | 1.5< | 1.5< | 1.5< | 1.5< | 0.07 | 0.08 | 0.1 |
| (wt %/C) | | | | | | | | | | | | |
| Drying shrinkage-reducing effect (%) | 31.0 | 35.4 | 34.2 | 38.5 | 33.0 | 24.1 | 33.5 | 30.5 | 20.2 | 6.1 | 8.2 | 7.1 |

※1: In the formula (2), R⁵ = H, R⁶ = H, R⁷ = CH₃, R⁸ = C₂H₄, R⁹ = CH₃, s = 0, u = 23
※2: In the formula (2), R⁵ = H, R⁶ = H, R⁷ = CH₃, R⁸ = C₂H₄, R⁹ = CH₃, s = 0, u = 9
※3: In the formula (2), R⁵ = H, R⁶ = H, R⁷ = CH₃, R⁸ = C₂H₄, R⁹ = C₁₂H₂₅, s = 0, u = 25
※4: In the formula (2), R⁵ = H, R⁶ = H, R⁷ = CH₃, R⁸ = C₂H₄, R⁹ = C₁₈H₃₇, s = 0, u = 25
※5: In the formula (2), R⁵ = H, R⁶ = H, R⁷ = CH₃, R⁸ = C₂H₄, R⁹ = C₅H₁₁, s = 0, u = 25
※6: In the formula (3), R¹⁰ = H, R¹¹ = H, R¹² = CH₃, R¹³ = C₂H₄, R¹⁴ = H, x = 2, y = 10

Table 1 shows that the polymers containing the structural unit (I) and having surface tension in the range of 25-50 mN/m could manifest significantly high drying shrinkage-reducing effect as compared with the polymers containing no structural unit (I) (comparative polymers 2 and 3) and the polymer containing the structural unit (I) but having surface tension exceeding the scope mentioned above (comparative polymer 1), indicating that the polymers according to this invention can effectively repress the shrinkage due to drying. It also shows that the polymers (1)-(9) of this invention containing the structural unit (I) and the structural unit (II) as essential structural units and also containing the structural unit (III) in a proportion in the range of 0-30 mass % based on the total mass of the polymer showed significantly improved drying shrinkage-reducing properties, as compared with the comparative polymer (1) which contains the structural unit (I), structural unit (II), and structural unit (III) as essential structural units but contains the structural unit (III) in a proportion exceeding 30 mass % based on the total mass of the polymer, indicating that the introduction of the structural unit (II) and a specific proportion of the structural unit (III) to the polymer resulted in imparting excellent drying shrinkage-reducing effect to the produced polymer.

### Production Example 10

In a glass reaction vessel equipped with a thermometer, a stirrer, a dropping funnel, a nitrogen conducting tube, and a reflux condenser, 1698 parts of deionized water was placed and stirred while the interior of the reaction vessel was displaced with nitrogen and heated under an atmosphere of nitrogen to 80° C. Next, an aqueous monomer mixture solution was prepared by mixing 1668 parts of methoxypolyethylene glycol monomethacrylate (average addition mol number of ethylene oxide of 25), 332 parts of methacrylic acid, and 500 parts of deionized water and further uniformly mixing 16.7 parts of 3-mercaptopropionic acid as a chain transfer agent therewith. The resultant aqueous monomer mixture solution and 184 parts of an aqueous 10% ammonium persulfate solution were independently added dropwise over a period of four hours. After the dropwise addition was completed, 46 parts of an aqueous 10% ammonium persulfate solution was added dropwise thereto over a period of one hour. Thereafter, the interior temperature of the reaction vessel was continuously maintained at 80° C. for one hour to complete the polymerization. The resultant reaction solution was neutralized to pH 7 by the use of an aqueous sodium hydroxide solution at a temperature not higher than the polymerization temperature, to obtain a copolymer (PC-1) (weight average molecular weight 24,000) which was used as a polycarboxylic acid type dispersing agent (A) formed of the aqueous polymer solution. The weight average molecular weight of the copolymer (PC-1) was determined in the same manner as in Comparative Production Example 1.

### Production Example 11

In a glass reaction vessel equipped with a thermometer, a stirrer, a dropping funnel, a nitrogen conducting tube, and a reflux condenser and having an inner volume of one liter, 3.1 parts of deionized water, 66.9 parts of an aqueous 80% solution of polyalkylene glycol monoalkenyl ether monomer having 50 mols of ethylene oxide added to 3-methyl-3-buten-1-ol (hereinafter referred to as “IPN-50”), and 2.8 parts of an aqueous 30% solution of hydrogen peroxide were placed and heated in an atmosphere of nitrogen to 58° C. Next, a mixed solution consisting of 267.6 parts of an aqueous 80% solution of IPN-50, 34.7 parts of deionized water, and 2.5 parts of lauryl mercaptan and a mixed solution consisting of 36.2 parts of acrylic acid and 9.0 parts of deionized water were added dropwise over three hours and a mixed solution consisting of 1.1 parts of L-ascorbic acid and 19.9 parts of deionized water was simultaneously added dropwise over 3.5 hours. After the dropwise addition was completed, the components in the reaction vessel were left aging continuously at 58° C. for 1.0 hour, then cooled to room temperature, and adjusted to pH 6.7 with an aqueous 30% sodium hydroxide solution. Consequently, an aqueous solution of the copolymer (PC-2) (weight average molecular weight 21,900) which was used as a polycarboxylic acid type dispersing agent (B) formed of the aqueous polymer solution was obtained. The weight average molecular weight of the copolymer (PC-2) was determined in the same manner as in Comparative Production Example 1.

### Examples 10-18 and Comparative Examples 4-6

The polymers (2)-(7) of this invention produced by following the procedures of Production Examples 2-7 and the comparative polymer (1) produced by following the procedure of Comparative Production Example 1 were tested for the mortar flow value and the drying shrinkage-reducing effect. The results are shown in Table 2 below.

3. Determination of Mortar Flow Value

The mortar flow value was determined in accordance with the method described in JIS R 5201-1997 with necessary modifications.

4. Drying Shrinkage-Reducing Effect

The kneading of mortar was carried out on the polymers (2)-(7) of this invention, FC-900 (polycarboxylic acid type dispersing agent, made by Nippon Shokubai K.K.), Pozzolith No. 70 (lignin sulfonic acid compound polyol complex type dispersing agent, made by Pozzolith Bussan K.K.), the copolymer PC-1 produced by following the procedure of Production Example 10, and the copolymer PC-2 produced by following the procedure of Production Example 11, as follows. In a Hobart type mortar mixer, Model No. N-50 (made by Hobart K.K.), 213.7 g of a dilution prepared by weighing a given polymer in the amount as shown in Table 2 below and diluting it with water, 485.8 g of ordinary portland cement made by Taiheiyo Cement K.K., and 1350 g of a standard sand for testing cement strength (specified in 5.1.3., Annex 2 to JIS {Japanese Industrial Standard} R 5201-1997) were kneaded into a mortar in accordance with JIS R 5201-1997. In this case, the air content of a given mortar was adjusted, when necessary, by selecting and using a defoaming agent so as to have the amount of air entrained by the mortar fall in the range of 5.0-10.0 vol %.

Next, a mortar test specimen (4×4×16 cm) for testing the drying shrinkage-reducing effect was prepared in accordance with JIS R 1129.

The retaining mold was coated in advance with silicone grease in order to obtain waterproofness and facilitate release therefrom. The test specimen had gauge plugs attached one each to the opposite ends thereof. The mortar resulting from the kneading was pored into the retaining mold. Then, the mold was placed in a container, sealed tightly therein and retained at 20° C. to effect initial curing. Two days thereafter, the cured mortar was extracted from the retaining mold, the silicone grease adhering to the mold was removed by washing with a scrubbing brush and water, and subsequently the mortar was left aging in still water at 20° C. for five days (curing in water).

A dial gauge (made by Nishinippon Shikenki K.K.) was used in accordance with JIS A 1129. The test specimen cured in the still water for five days was wiped with paper towel to remove the water remaining on the surface thereof and immediately measured to determine the length thereof. The length found at this point was taken as a standard. Thereafter, the test specimen was stored in a thermo-hygrostat set at a temperature of 20° C. and 60% of humidity for 28 days, during which period the length of the test specimen was measured at proper intervals. In this case, the drying shrinkage-reducing effect was reported as a value of the decrease in the shrinkage at the time of addition of the polymer relative to the amount of shrinkage of the standard. This value increased in accordance as the decrease in the shrinkage grew. The value of not more than 10% was regarded that the shrinkage-reducing effect was absent. In the following formula, the amount of shrinkage of the standard was regarded as the amount of shrinkage of (Comparative Example 5) which used Pozzolith No. 70 in an amount of 0.25 wt %/C.
Drying shrinkage-reducing effect (%)={[(Amount of shrinkage of standard)−(Amount of shrinkage of polymer)]/(Amount of shrinkage of standard)}×100 [Formula 2]

TABLE 2

| | | Exam- | Exam- | Exam- | Exam- | Exam- | Exam- | Exam- | Exam- | Exam- | Control | Control | Control |
|---|---|---|---|---|---|---|---|---|---|---|---|---|---|
| | | ple 10 | ple 11 | ple 12 | ple 13 | ple 14 | ple 15 | ple 16 | ple 17 | ple 18 | 4 | 5 | 6 |
| Added | FC-900 | 0.05 | | | | | | | | | 0.05 | | |
| amount | Pozzolith | | 0.25 | | | | | | | | | 0.25 | |
| (wt %/C) | No. 70 | | | | | | | | | | | | |
| | PC-1 | | | | 0.05 | | 0.05 | | 0.05 | | | | |
| | PC-2 | | | 0.05 | | 0.05 | | 0.05 | | 0.05 | | | 0.05 |
| | Polymer 2 | 1.50 | 1.50 | 1.50 | | | | | | | | | |
| | Polymer 4 | | | | 1.50 | 1.50 | | | | | | | |
| | Polymer 6 | | | | | | 1.50 | 1.50 | | | | | |
| | Polymer 7 | | | | | | | | 1.50 | 1.50 | | | |

| | | | | | | | | | | | | |
|---|---|---|---|---|---|---|---|---|---|---|---|---|
| Mortar flow value | 181 | 177 | 173 | 178 | 179 | 182 | 175 | 174 | 177 | 182 | 175 | 174 |
| (mm) | | | | | | | | | | | | |
| Drying shrinkage- | 30.2 | 26.5 | 33.5 | 33.3 | 36.2 | 20.3 | 23.5 | 29.0 | 32.5 | 3.8 | 0 | 7.2 |
| reducing effect (%) | | | | | | | | | | | | |

Table 2 shows that by using the polymers (2)-(7) according to this invention in combination with FC-900 (polycarboxylic acid type dispersing agent), Pozzolith No. 70 (lignin sulfonic acid compound polyol complex type dispersing agent), or the copolymer PC-1 or PC-2, the dispersibility and the drying shrinkage-reducing effect can be attained to the levels as aimed at. The table further shows that the Comparative examples 4-6 which used solely a dispersing agent exhibited insufficient drying shrinkage-reducing properties, although they manifested sufficient dispersibility (mortar flow value).

### INDUSTRIAL APPLICABILITY

The drying shrinkage-reducing agent of this invention has a composition as described above. When it is applied to a hydraulic material such as cement paste, mortar, and concrete, it can manifest outstanding effects for repressing a crack. Accordingly, the drying shrinkage-reducing agent of this invention can improve the strength and durability of a cured product, exalt the safety of civil engineering and constructional structures, and repress the cost of repair.

The entire disclosure of Japanese Patent Application No. 2004-074017 filed on Mar. 16, 2004 including specification, claims, drawings and summary are incorporated herein by reference in its entirety.

1. A drying shrinkage-reducing agent which comprises a polymer containing as an essential component at least one structural unit (I) represented by the following formula (1): 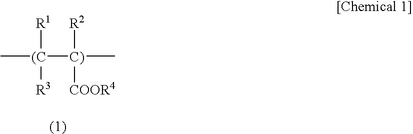
wherein R¹, R², and R³ independently stand for a hydrogen atom, a methyl group, or a —(CH₂)ₚCOOX group, wherein X stands for a hydrogen atom, a monovalent metal, a divalent metal, an ammonium group, an organic amine group, or a hydrocarbon group, and p is an integer of 0-2; and R⁴ stands for a hydrocarbon group of 4-30 carbon atoms,
and exhibiting surface tension in the range of 25-50 mN/m in a solution containing 0.2 mass % of the polymer in a cement supernatant.

2. A drying shrinkage-reducing agent according to claim 1 wherein said polymer contains as essential components at least one structural unit (I) represented by the formula (1); and at least one structural unit (II) selected among a structural unit (II-a) represented by the following formula (2): 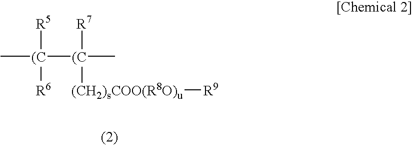
wherein R⁵, R⁶ and R⁷ independently stand for a hydrogen atom or a methyl group; s is an integer of 0-2; R⁸O stands for one oxyalkylene group of 2-18 carbon atoms or a mixture of two or more such oxyalkylene groups; u stands for an average addition mol number of oxyalkylene group (R⁸O) and is in the range of 1-300; and R⁹ stands for a hydrogen atom or a hydrocarbon group of 1-30 carbon atoms, and a structural unit (II-b) represented by the following formula (3): 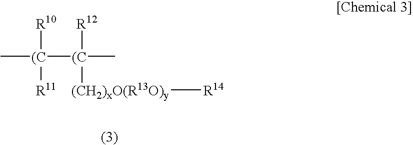
wherein R¹⁰, R¹¹ and R¹² independently stand for a hydrogen atom or a methyl group; x is an integer of 0-2; R¹³O stands for one oxyalkylele group of 2-18 carbon atoms or a mixture or two or more such groups; y stands for an average addition mol number of the oxyalkylene group (R¹³O) and is in the range of 1-300; and R¹⁴ stands for a hydrogen atom or a hydrocarbon group of 1-30 carbon atoms, and contains at least one structural unit (III) represented by the following formula (4): 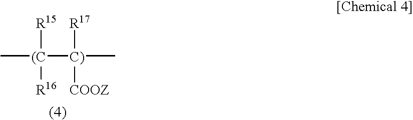
wherein R¹⁵, R¹⁶ and R¹⁷ independently stand for a hydrogen atom, a methyl group, or a —(CH₂)_{q}COOZ′, wherein Z′ stands for a hydrogen atom, a monovalent metal, a divalent metal, an ammonium group, or an organic amine group, and q is an integer of 0-2; and Z stands for a hydrogen atom, a monovalent metal, a divalent metal, an ammonium group, or an organic amine group, provided that if COOZ′ and COOZ are present in the total number of not less than 2, two of them may form an anhydride, in a proportion in the range of 0-30 mass % based on the total mass of the polymer.

3. A drying shrinkage-reducing agent according to claim 1, wherein said structural unit (I) is present in a proportion in the range of 7-99 mass % based on the total mass of the polymer.

4. A drying shrinkage-reducing agent according to claim 1, which is used in a hydraulic material.

5. A shrinkage-reducing composition comprising at least one drying shrinkage-reducing agent set forth in claim 1 and a dispersing agent.

6. A shrinkage-reducing composition according to claim 5, wherein the mass ratio of the drying shrinkage-reducing agent and the dispersing agent is in the range of 99.5:0.5-0.5:99.5.

7. A drying shrinkage-reducing agent according to claim 2, wherein said structural unit (I) is present in a proportion in the range of 7-99 mass % based on the total mass of the polymer.

8. A drying shrinkage-reducing agent according to claim 2, which is used in a hydraulic material.

9. A drying shrinkage-reducing agent according to claim 3, which is used in a hydraulic material.

10. A shrinkage-reducing composition comprising at least one drying shrinkage-reducing agent set forth in claim 2 and a dispersing agent.

11. A shrinkage-reducing composition comprising at least one drying shrinkage-reducing agent set forth in claim 3 and a dispersing agent.

12. A shrinkage-reducing composition comprising at least one drying shrinkage-reducing agent set forth in claim 4 and a dispersing agent.
